(19) United States
(12) Patent Application Publication
(10) Pub. No.: US 2004/0043770 A1
(43) Pub. Date: Mar. 4, 2004

(54) Broadcast content over cellular telephones

(76) Inventors: Assaf Amit, Ramat Gan (IL); Yarden Admon, Ramat Gan (IL); Shilo De-Beer, Herzliya (IL)

Correspondence Address: WELSH & KATZ, LTD, 120 S RIVERSIDE PLAZA, 22ND FLOOR, CHICAGO, IL, 60606, US

(21) Appl. No.: 10/332,383

(22) PCT Filed: Jul. 8, 2001
(86) PCT No.: PCT/IL01/00623

(51) Int. Cl. H04Q 7/20

(52) U.S. Cl. 455/450

(57) ABSTRACT

A method for broadcasting information, comprising providing at a host site (20) computer-readable code representing a sequence of frames of content of a broadcast channel, receiving signals at the host site from a plurality of mobile telephone devices (75) via a wireless network, invoking the broadcast channel, and transmitting the code via the wireless network to the plurality of mobile telephone devices concurrently, causing the devices to display the sequence of frames to respective users of the devices substantially simultaneously.

### CROSS-REFERENCE TO RELATED APPLICATIONS

This application claims the benefit of U.S. provisional patent application No. 60/217,218, filed Jul. 10, 2000 which is incorporated herein by reference.

### FIELD OF THE INVENTION

The present-invention relates to the field of telephonic services, particularly to methods and apparatus for time-based broadcast to cellular telephones.

### BACKGROUND OF THE INVENTION

Time-based content is a well-known media concept, familiar to everyone who uses traditional mainstream media such as radio and television. In order to receive a specific show or program, a user merely has to tune his radio or television to the specific channel at the correct time. Time-based content is not offered today over mobile phones.

Data services are provided over mobile phones in such a manner that people are expected to define the content that they want to receive by navigating through drill down menus. This menu-driven model of content provision is time-consuming and inconvenient to use. Furthermore, many potential users are unfamiliar with menu-based systems, and are thereby deterred from using such technology.

PCT publication WO 98/56188 to Sony Electronics Inc. describes apparatus and methods for displaying both Internet material and television programming on a television set.

PCT publication WO 00/64211 to Nokia Mobile Phones Ltd. describes a method for transmitting information related to the use of Wireless Application Protocol (WAP) between a first device and a second device coupled to a packet switched data transmission network.

Details of various technologies that may be useful in the present invention may be found in the following references:

“Platform SDK: DirectPlay”, Microsoft, September 1999 (msden.microsoft.corn/library/psdk/directx/dpover_{—}61ql.htm).

“Mobile Entertainment Service: Developers Guide”, Nolia, May 2000 (www.nokia,corn/wap/entertainmenthtml).

“The Basics of WAP Game Design”, E. Wells, April 2000 (www.wirelessdevnet.com/articles/apr2000/wirelessgaming.html).

“Hypertext Transfer Protocol—HTTP/1.1”, R. Fielding, et al., January 1997 (ftp.isi.edu/in-notes/rfc2068.txt).

“DoCoMo Report: Internet-Compatible “i-mode” Cell Phones Captivate Japanese Market”, NTT DoCoMo, May 2000 (www.nttdocomo.com/topics/tp990527.htm).

“Microsoft Mobile Explorer: White Paper”, Microsoft Corp., January 2000 (www.microsoft.com/mobile.mme).

“WAP Push Architectural Overview”, WAP Forum, November 1999 (www.wapforum.org).

“Wireless Application Protocol Architecture Specification”, WAP Forum, April 1998 (www.wapforum.org).

“Wireless Telephony Application Interface Specification”, WAP Forum, April 1998 (www.wapforum.org).

“Developing User Friendly Applications”, Phone.Com, August 1999 (developer.phone.com).

“Extensible Markup Language (XML)”, T. Bray, et al, February 1998 (www.w3.org/TR/REC-xml).

There is thus a need in the art for an apparatus and method for providing time-based broadcast content over mobile telephones.

The disclosures of the publications mentioned in this section and in other sections of the specification, are incorporated herein by reference, each in its entirety.

### SUMMARY OF THE INVENTION

It is an object of some aspects of the present invention to provide novel apparatus and methods for broadcast of streaming content to mobile phones and similar client devices. “Streaming” refers to any kind of content that, once chosen, keeps on coming by itself (as opposed to content waiting to be retrieved from menus). “Broadcast” means that all people tuned into the same channel receive the same program at the same time, hence enabling content to be time-based rather than menu-driven.

Preferred embodiments of the present invention are based upon server-side software that does not require any modification or software manipulation on the client side. Mobile phones with microbrowser software, as is currently provided in most new cellular telephones for WAP applications, can be used for receiving the service.

Time-based broadcasts over mobile telephones can provide a new dimension of telephone use to masses of people who are looking for simple and relaxing ways to be entertained, and to “outsource” their content management to the channel producer in the same way as when we turn on the TV or the radio. All the users need to do is to pick a channel and then watch the specified channel, over the mobile phone, for as long as they like.

Preferably, it is possible for users to switch between the offered channels. In a further preferred embodiment, it is possible to access other interactive features associated with the streaming content, preferably by selecting an appropriate on-screen control that is presented as part of the streaming content.

Preferred embodiments of the present invention support different formats of content that can be streamed using existing wireless networks and phones. Current cellular networks and existing handsets are unable to stain the amount of stable bandwidth demanded by streaming video (typically 19.2 Kbps to 28.8 Kbps). Therefore, in accordance with a preferred embodiment of the present invention, a “lighter” kind of streaming content is broadcast, such as text, images, simple animation effects, and comic strips. These visual elements can be combined to create streaming channels that run over current-generation mobile phones. They can be enhanced with richer media elements as soon as the networks and handsets are able to support them.

In preferred embodiments of the present invention, a dedicated server receives content input from a range of sources and converts the input to a special, unified mark-up language form for delivery to a multiplicity of subscribers/users in parallel. The server typically performs a number of functions including ensuring that users receive the correct format of content for their specific handsets and current quality of service conditions, and handling interactive events generated by user responses to on-screen controls. The server preferably includes content conversion modules that are able to bring real-time content to the channels from online sources such as Web sites and chat rooms.

There is thus provided, in accordance with a preferred embodiment of the present invention, a method for broadcasting information, including providing at a host site computer-readable code representing a sequence of frames of content of a broadcast channel, receiving signals at the host site from a plurality of mobile telephone devices via a wireless network, invoking the broadcast channel, and transmitting the code via the wireless network to the plurality of mobile telephone devices concurrently, causing the devices to display the sequence of frames to respective users of the devices substantially simultaneously.

Preferably, the network includes a cellular telephone network.

Further in accordance with a preferred embodiment of the present invention, the code is transmitted as packet data over the cellular telephone network.

Still further in accordance with a preferred embodiment of the present invention, the data is transmitted in accordance with a Wireless Access Protocol (WAP).

Further in accordance with a preferred embodiment of the present invention, providing the code includes generating the code in a mark-up language, which is read by respective browser programs running on the mobile telephone devices. Preferably, the mark-up language includes a language selected from a group of languages consisting of Extensible Markup Language (XML), Wireless Markup Language (WML), Hypertext Markup Language (HTML) and Handheld Device Markup Language (HDML).

Still further in accordance with a preferred embodiment of the present invention, generating the code includes generating multiple pages of the mark-up language code, and transmitting the code includes transmitting the mark-up language code together with scripts, which cause the browser programs to display the content of the multiple pages in succession.

Additionally in accordance with a preferred embodiment of the present invention, receiving the signals includes receiving indications of respective display capabilities of the mobile telephone devices, and transmitting the code includes transmitting different code versions to different ones of the mobile telephone devices responsive to the display capabilities thereof.

Also in accordance with a preferred embodiment of the present invention, receiving the signals includes estimating respective bandwidths available on the network between the mobile telephone devices and the host site based on the received signals, and transmitting the code includes transmitting different code versions to different ones of the mobile telephone devices responsive to the respective estimated bandwidths.

Further in accordance with a preferred embodiment of the present invention, transmitting the code includes synchronizing the code among the mobile telephones so that the frames are displayed to the users on a common timeline.

Still further in accordance with a preferred embodiment of the present invention, each of the frames includes one or more slides, each of the one or more slides including at least one of text and an image for display by the mobile telephone devices.

Additionally in accordance with a preferred embodiment of the present invention, at least one of the frames includes a link to an application, and the method also includes receiving an input from one or more of the users invoking the link, and conveying the application to the mobile telephone devices responsive to the input.

Further in accordance with a preferred embodiment of the present invention, providing the code includes providing multiple codes representing the content of multiple broadcast channels, and invoking the broadcast channel includes selecting one of the multiple broadcast channels to be displayed on each of the mobile telephone devices.

There is further provided in accordance with another preferred embodiment of the present invention, a method for broadcasting information, including providing at a host site multiple pages of computer-readable markup-language code representing content of a broadcast channel, receiving signals at the host site from a plurality of mobile telephone devices via a wireless network, invoking the broadcast channel, and transmitting the code via the wireless network to the plurality of mobile telephone devices together with scripts, which cause respective browser programs running on the devices to display the content of the multiple pages in succession to respective users of the devices substantially simultaneously.

Further in accordance with a preferred embodiment of the present invention, the browser programs include microbrowser programs installed as firmware in the mobile telephone devices, and the scripts are written in a scripting language that is executable by the microbrowser programs substantially as installed.

Still further in accordance with a preferred embodiment of the present invention, transmitting the code includes transmitting the code to the mobile telephone devices in accordance with a wireless communication protocol, and the scripts cause the mobile telephone devices, upon displaying the content of one of the pages, to request a successive one of the pages from the host site using the protocol.

Additionally in accordance with a preferred embodiment of the present invention, at least one of the pages includes a link to alternative content, such that invocation of the link by one of the users causes the mobile telephone of the one of the users to send a link signal to the host site responsive to one of the scripts associated with the link, and transmitting the code includes receiving the link signal and, responsive thereto, transmitting the alternative content to the one of the users while the mobile telephone devices of the other users continue to display the multiple pages in succession.

Also in accordance with a preferred embodiment of the present invention, transmitting the alternative content includes conveying an interactive application to the mobile telephone of the one of the users.

Further in accordance with a preferred embodiment of the present invention, providing the code includes providing the multiple pages representing the content of a multiplicity of broadcast channels, wherein transmitting the alternative content includes transmitting to the one of the users the code of a second one of the broadcast channels in place of the code of a first one of the broadcast channels.

Still further in accordance with a preferred embodiment of the present invention, the method further includes receiving an indication that the one of the users has finished viewing the alternative content, and transmitting the code includes continuing to transmit the multiple pages to the one of the users, responsive to the indication, in synchronization with the other users.

Additionally in accordance with a preferred embodiment of the present invention, receiving the link signal includes receiving the signal invoked by the script associated with the link responsive to the user pressing a button on the telephone device.

There is further provided in accordance with another preferred embodiment of the present invention, a method for broadcasting information, including providing at a host site computer-readable code representing a sequence of frames of content of a broadcast channel, receiving signals at the host site from a plurality of mobile telephone devices via a wireless network, invoking the broadcast channel, estimating available network bandwidth between the host site and each of the plurality of mobile telephone devices, based on the received signals, selecting different versions of the code to transmit to the mobile telephone devices responsive to the available network bandwidth for each of the devices, and transmitting the different code versions via the wireless network to the plurality of mobile telephone devices concurrently, causing the devices to display the sequence of frames to respective users of the devices substantially simultaneously.

Further in accordance with a preferred embodiment of the present invention, the different versions of the code include different volumes of code data in at least some of the frames in the sequence.

Still further in accordance with a preferred embodiment of the present invention, estimating the available network bandwidth includes sending a test signal from the host site to each of the mobile telephone devices, and measuring an elapsed time until the signals are received at the host site from the mobile telephone devices in response to the test signal.

Additionally in accordance with a preferred embodiment of the present invention, the available network bandwidth is estimated to be inversely proportional to the elapsed time.

Also in accordance with a preferred embodiment of the present invention, the method also includes periodically repeating the estimating and selecting steps while transmitting the code versions.

Further in accordance with a preferred embodiment of the present invention, receiving the signals further includes receiving indications of respective display capabilities of the mobile telephone devices, and transmitting the different code versions includes transmitting the different versions to different ones of the mobile telephone devices responsive to the display capabilities thereof.

Still further in accordance with a preferred embodiment of the present invention, transmitting the different code versions includes synchronizing the code versions among the mobile telephones so that the frames are displayed to the users on a common timeline.

Additionally in accordance with a preferred embodiment of the present invention, providing the code includes generating a basic code, and transmitting the different code versions includes processing the basic code so as to generate the different code versions in a mark-up language, which is read by respective browser programs running on the mobile telephone devices.

There is also provided in accordance with another preferred embodiment of the present invention, a method for broadcasting information, including providing at a host site basic markup language code representing a sequence of frames of content of a broadcast channel, receiving signals at the host site from a plurality of mobile telephone devices via a wireless network, indicative of respective capabilities of the devices to receive and display the content, generating different versions of the basic markup language code to transmit to the mobile telephone devices responsive to the respective capabilities of the devices, and transmitting the different code versions via the wireless network to the plurality of mobile telephone devices concurrently, causing respective browser programs running on the devices to read the markup language code and, responsive thereto, to display the sequence of frames to respective users of the devices substantially simultaneously.

Further in accordance with a preferred embodiment of the present invention, generating the different versions includes generating the versions in one or more languages selected from a group of languages consisting of Extensible Markup Language (XML), Wireless Markup Language (WML), Hypertext Markup Language (HTML) and Handheld Device Markup Language (HDML).

Still further in accordance with a preferred embodiment of the present invention, providing the basic code includes providing multiple pages of the code, and wherein transmitting the different code versions includes transmitting the different code versions together with scripts, which cause the browser programs to display the content of the multiple pages in succession.

Additionally in accordance with a preferred embodiment of the present invention, providing the basic code includes collecting the content from a plurality of content sources, and converting the content to the basic markup language code.

Also in accordance with a preferred embodiment of the present invention, converting the content includes assembling the content into clips corresponding to the frames, each clip including one or more pages of the basic markup language, and providing a schedule indicative of the sequence of the frames, wherein transmitting the different code versions includes transmitting the versions in accordance with the schedule.

Further in accordance with a preferred embodiment of the present invention, assembling the content into the clips includes defining clip objects in the basic markup language.

Still further in accordance with a preferred embodiment of the present invention, collecting the content includes identifying fields on a selected Web page containing the content, and periodically polling the fields on the selected Web page to determine whether the content in the fields has changed, and converting the changed content to the basic markup language.

Additionally in accordance with a preferred embodiment of the present invention, generating the different versions includes converting the basic markup language code for one of the frames in the sequence to the different versions while transmitting the different versions of a preceding one of the frames in the sequence to the mobile telephone devices.

Further in accordance with a preferred embodiment of the present invention, generating the different versions includes producing the versions responsive to different estimates of bandwidth available on the network between the host site and the mobile telephone devices.

Also in accordance with a preferred embodiment of the present invention, generating the different versions includes producing two or more of the different versions in different markup languages.

There is further provided in accordance with another preferred embodiment of the present invention, a wireless broadcast server, including a processor, coupled to receive signals via a wireless network from a plurality of mobile telephone devices, invoking a broadcast channel, and to transmit computer-readable code representing content of the broadcast channel via the wireless network to the plurality of mobile telephone devices concurrently, causing the devices to display the content to respective users of the devices substantially simultaneously.

There is still further provided in accordance with another preferred embodiment of the present invention, a wireless broadcast server, including a processor, coupled to receive signals via a wireless network from a plurality of mobile telephone devices, involving a broadcast channel, and to transmit multiple pages of computer-readable markup-language code representing content of a broadcast channel via the wireless network to the plurality of mobile telephone devices together with scripts, which cause respective browser programs running on the devices to display the content of the multiple pages in succession to respective users of the devices substantially simultaneously.

There is also provided in accordance with another preferred embodiment of the present invention, a wireless broadcast server, including a processor, coupled to receive signals via a wireless network from a plurality of mobile telephone devices, invoking a broadcast channel, to estimate available network bandwidth between the server and each of the plurality of mobile telephone devices, based on the received signals, to select, responsive to the available network bandwidth for each of the devices, different versions of a computer-readable code representing a sequence of frames of content of the broadcast channel, for transmission to the mobile telephone devices, and to transmit the different code versions via the wireless network to the plurality of mobile telephone devices concurrently, causing the devices to display the sequence of frames to respective users of the devices substantially simultaneously.

There is further provided in accordance with another preferred embodiment of the present invention, a wireless broadcast server, including a processor, coupled to generate different versions of a basic markup language code representing a sequence of frames of content of a broadcast channel, to receive signals via a wireless network from a plurality of mobile telephone devices, indicative of respective capabilities of the devices to receive and display the content, to transmit, responsive to the respective capabilities of the devices, the different code versions via the wireless network to the plurality of mobile telephone devices concurrently, causing respective browser programs running on the devices to read the markup language code and, responsive thereto, to display the sequence of frames to respective users of the devices substantially simultaneously.

There is yet further provided in accordance with another preferred embodiment of the present invention, a computer software product, including a computer-readable medium in which program instructions are stored, which instructions, when read by a computer, cause the computer to receive signals via a wireless network from a plurality of mobile telephone devices, invoking a broadcast channel, and to transmit computer-readable code representing content of the broadcast channel via the wireless network to the plurality of mobile telephone devices concurrently, causing the devices to display the content to respective users of the devices substantially simultaneously.

There is additionally provided in accordance with another preferred embodiment of the present invention, a computer software product, including a computer-readable medium in which program instructions are stored, which instructions, when read by a computer, cause the computer to receive signals via a wireless network from a plurality of mobile telephone devices, invoking a broadcast channel, and to transmit multiple pages of computer-readable markup-language code representing content of the broadcast channel via the wireless network to the plurality of mobile telephone devices together with scripts, which cause respective browser programs running on the devices to display the content of the multiple pages in succession to respective users of the devices substantially simultaneously.

There is also provided in accordance with another preferred embodiment of the present invention, a computer software product, including a computer-readable medium in which program instructions are stored, which instructions, when read by a computer, cause the computer to receive signals via a wireless network from a plurality of mobile telephone devices, invoking a broadcast channel, to estimate available network bandwidth between the server and each of the plurality of mobile telephone devices, based on the received signals, to select, responsive to the available network bandwidth for each of the devices, different versions of a computer-readable code representing a sequence of frames of content of the broadcast channel, for transmission to the mobile telephone devices, and to transmit the different code versions via the wireless network to the plurality of mobile telephone devices concurrently, causing the devices to display the sequence of frames to respective users of the devices substantially simultaneously.

There is further provided in accordance with another preferred embodiment of the present invention, a computer software product, including a computer-readable medium in which program instructions are stored, which instructions, when read by a computer, cause the computer to generate different versions of a basic markup language code representing a sequence of frames of content of a broadcast channel, to receive signals via a wireless network from a plurality of mobile telephone devices, indicative of respective capabilities of the devices to receive and display the content, to transmit, responsive to the respective capabilities of the devices, the different code versions via the wireless network to the plurality of mobile telephone devices concurrently, causing respective browser programs running on the devices to read the markup language code and, responsive thereto, to display the sequence of frames to respective users of the devices substantially simultaneously.

### BRIEF DESCRIPTION OF THE DRAWINGS AND APPENDIX

The present invention will be understood and appreciated more fully from the following detailed description, taken in conjunction with the drawings in which:

FIG. 1 is a schematic, pictorial illustration of a system for broadcast of content over mobile telephones, constructed and operative in accordance with a preferred embodiment of the present invention;

FIG. 2 is a block diagram that schematically shows details of a content server used in the system of FIG. 1, constructed and operative in accordance with a preferred embodiment of the present invention;

FIG. 3 is a schematic block diagram illustrating channel content elements, in accordance with a preferred embodiment of the present invention;

FIG. 4 is a screen shot of a graphical user interface illustrating the creation of channel content for delivery by the system of FIG. 1, in accordance with a preferred embodiment of the present invention;

FIGS. 5A-5G are a series of screens from the query phase of a survey, in accordance with a preferred embodiment of the present invention;

FIGS. 6A-6H are a series of screens from the results phase of a survey, in accordance with a preferred embodiment of the present invention;

FIG. 7 is a block diagram that schematically shows apparatus for content conversion, constructed and operative in accordance with a preferred embodiment of the present invention; and

FIG. 8 is a schematic illustration of a mobile phone displaying converted content on a display screen, in accordance with a preferred embodiment of the present invention.

Appendix A is document type definition (DTD) for the Viven Clip Tag Language (VCTL).

### DETAILED DESCRIPTION OF PREFERRED EMBODIMENTS

As used herein, the following terms have the meanings ascribed to them below:

Device: a network entity capable of sending and receiving packets of information and having a unique device address.

Microbrowser: A modified Web browser that allows users to get Internet data on a handheld wireless device.

Network Bearer: the data transport mechanism used to carry data over a wireless network. Examples of network bearers known in the art include GSM SMS, GSM CSD, CDPD, GPRS, and IDEN.

Terminal: a device providing a user with the ability to request and receive content.

User: a person who interacts with a terminal to view, hear, or otherwise interact with content. (A user may also be referred to as a subscriber.)

WML: Wireless Markup Language—a hypertext markup language used to represent information for delivery to a narrow-band device, e.g., a telephone.

XML: Extensible Markup Language—a World Wide Web Consortium (W3C) proposed standard for Internet markup languages, of which WML is one such language.

The following abbreviations are used herein.

| | |
|---|---|
| API: | Application Programming Interface |
| ASP: | Active Server Pages |
| CDMA: | Code Division Multiple Access |
| CDPD: | Cellular Digital Packet Data |
| CGI: | Common Gateway Interface |
| COM: | Component Object Model |
| CSD: | Circuit Switched Data |
| DTD: | Document Type Definition |
| GPRS: | General Packet Radio Service |
| GSM: | Global System for Mobile Communication |
| GUI: | Graphical User Interface |
| HDML: | Handheld Device Markup Language |
| HTML: | HyperText Markup Language |
| HTTP: | HyperText Transfer Protocol |
| iDEN: | Integrated Digital Enhanced Network |
| IIS: | Internet Information Server |
| IP: | Internet Protocol |
| IPDR: | IP Data Record |
| IRC: | Internet Relay Chat |
| MME: | Microsoft Mobile Explorer |
| OTA: | Over the Air |
| PDA: | Personal Digital Assistant |
| QoS: | Quality of Service |
| RDBMS: | Relational Database Management System |
| SDK: | Software Developer's Kit |
| SMS: | Short Message Service |
| SSL: | Secure Sockets Layer |
| VCTL: | Viven Clip Tag Language |
| W3C: | World Wide Web Consortium |
| WAP: | Wireless Application Protocol |
| WML: | Wireless Markup Language |
| WTLS: | Wireless Transport Layer Security |
| XML: | Extensible Markup Language |

System Overview

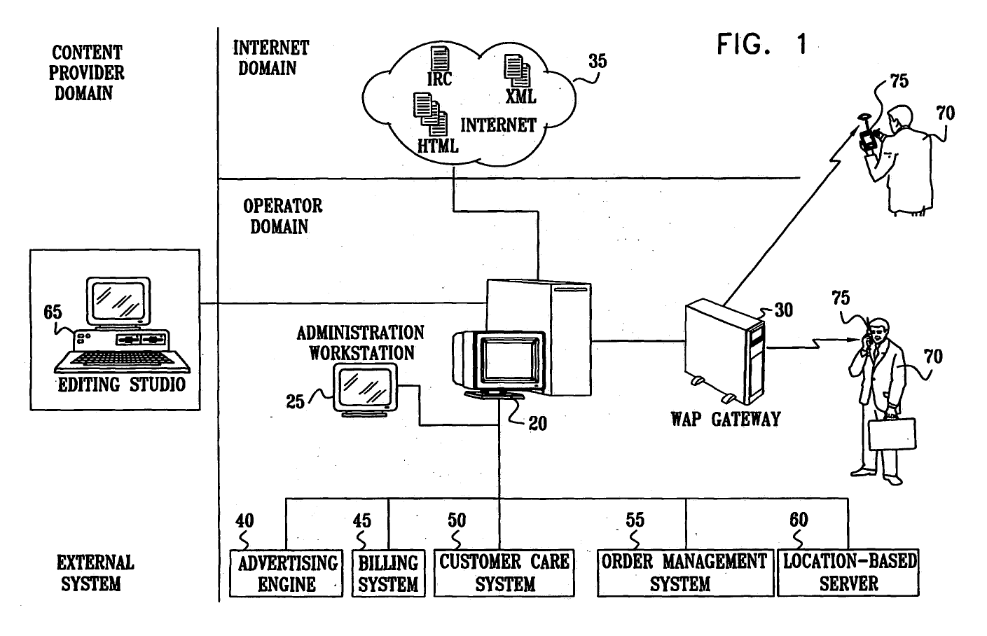

Reference is now made to FIG. 1 which is a schematic, pictorial illustration of a system for broadcast of content over mobile telephones 75, constructed and operative in accordance with a preferred embodiment of the present invention. Typically, a variety of content, formatted as a number of channels, is broadcast from a wireless content server 20 via a WAP gateway 30 to a user 70 or plurality of users 70. Preferably, the user access a main (or default) channel of server 20 via gateway 30, by pressing a key or sequence of keys on telephone 75, thus invoking a URL, in a manner known in the WAP art. In order to save the user complicated device configuration, OTA configuration of telephone 75 is preferably supported, and the user can change the Internet settings on the telephone simply by receiving a SMS message. Alternatively or additionally, when networks and devices will allow, the channel service provided by server 20 can be activated automatically upon the occurrence of specific events (device turned on, call ended, etc.), and can be deactivated when not used for a predefined time period, typically about ten minutes.

If the user wants to view one of the channels other than the default channel, he or she subsequently selects one of the channels offered by server 20, typically from a menu or list of bookmarks, and the content corresponding to that particular channel is received over the user's telephone 75. User 70 preferably selects the channel by pressing a button on telephone 75, although other selection methods known in the art, such as voice and speech recognition, can be employed. To change channels while connected to server 20, the user preferably need press only a single button, or two buttons at the most, in a manner similar to changing channels on a television set.

Telephone 75 can be any of the popular telephones in the market, including WAP handsets, that are equipped with a microbrowser, produced, for example by Motorola, Siemens, Ericsson, Nokia, and others. Although preferred embodiments are described herein with reference to WAP and content prepared using the associated WNL language, the principles of the present invention are also applicable to other standards such as HDML, cHTML, and XHTEML. Telephone 75 may be any Internet-enabled mobile phone 75, including both feature phones and smart phones, described below.

Feature phones are the simplest Internet-enabled mobile phones. They contain an embedded microbrowser, which enables the phone to access Internet content and services. In general, feature phones cannot be reprogrammed or gain substantial additional capabilities. Such phones have modest processing power and memory requirements, and are relatively inexpensive to manufacture.

The typical feature phone of today has a screen capable of displaying four or five lines of text vertically by 16 characters horizontally and 100×50 monochrome bitmaps. Examples include the Ericsson R320, the Nokia 7110 and the Motorola Timeport P7389. Some phones have larger screens with more display lines. The microbrowsers embedded in feature phones can support different languages and protocols, including the following:

i-Mode (Compact HTML)—a proprietary protocol developed by NTT DoCoMo. This protocol incorporates both a packet-switched network bearer and a tag language that is basically a simpler variant of HTML.

WAP (WML)—an open industry standard created by the WAP Forum for mobile Internet access. WAP includes WML that is the tag language for preparing Web pages for mobile microbrowsers.

HTML—the standard tag language for creating Web pages. Currently, supported wirelessly only by MME, which is not yet commercially available.

HDML—A proprietary tag language derived from HTML by Openwave (formerly Phone.Com), which also allows Internet access from wireless devices. This language is now considered to be obsolete, fully superseded by WML.

Some microbrowsers in feature phones also support script languages such as WMLScript (similar to JavaScript).

In a preferred embodiment, telephone 75 is WAP 1.1 compliant, supports WML and WMLscript, and displays images.

As used herein, the term smart phones includes devices such as telephones, PDAs, and handheld communicators, with wireless connectivity, that can run built-in applications as well as applications downloaded from the Internet, and typically run operating systems that are specifically designed to allow programmability. Thus, smart phones can grow to accommodate new user demands.

Smart phones require greater processing power and more memory than feature phones and are therefore more expensive. Usually smart phones also include a better display than feature phones (e.g., 160×240 pixels). Examples of smart phones include the Nokia 9000 series, the QUALCOMM pdQ, the Ericsson R380 and Samsung's I-Max. PDAs with wireless access (e.g., Palm VII) have similar characteristics. The common operating systems of smart phones are EPOC (from Symbian), PalmOS (3Com), Windows CE (Microsoft) and J2ME (Sun).

The present invention is preferably powered by server 20, comprising one or more computing devices, serving a multiplicity of users 70 in parallel. Server 20 is preferably able to support feature phones with very thin microbrowser clients capable only of interpreting a tag language (and possibly a script language), as well as smart phones with more advanced capabilities. When telephone 75 is a feature phone, server 20 preferably interacts with the microbrowsers via HTTP requests and responses.

In a preferred embodiment, server 20 comprises a standard Microsoft Windows™-based server with an Intel Pentium processor, or another suitable computing device as is known in the art. Server 20 preferably has a fast IP connection to a WAP gateway 30, as is known in the art, and a connection to the Internet 35 if real-time content from Web sites is to be included in the content provided to users 70. The novel capabilities of server 20, as described in detail hereinbelow, are preferably provided by a Win32 COM+ software application running on a Microsoft Windows 2000 Server, along with a relational database (SQL Server 7 or Oracle 8i Server) and a Microsoft IIS Web server. The application software may be downloaded to server 20 in electronic form, or it may alternatively be provided on tangible media, such as CD-ROM. For high performance, server 20 may comprise a Windows 2000 Advanced Server or Windows 2000 Datacenter. Alternatively, server 20 may use other operating systems, databases and Web server software, as are known in the art.

WAP gateway 30 may comprise any suitable WAP gateway known in the art, such as gateways produced by Openwave (UP.Link), Nokia, Ericsson, and Captaris (formerly Infinite Technologies). An administration workstation 25 is provided for overseeing operation of server 20.

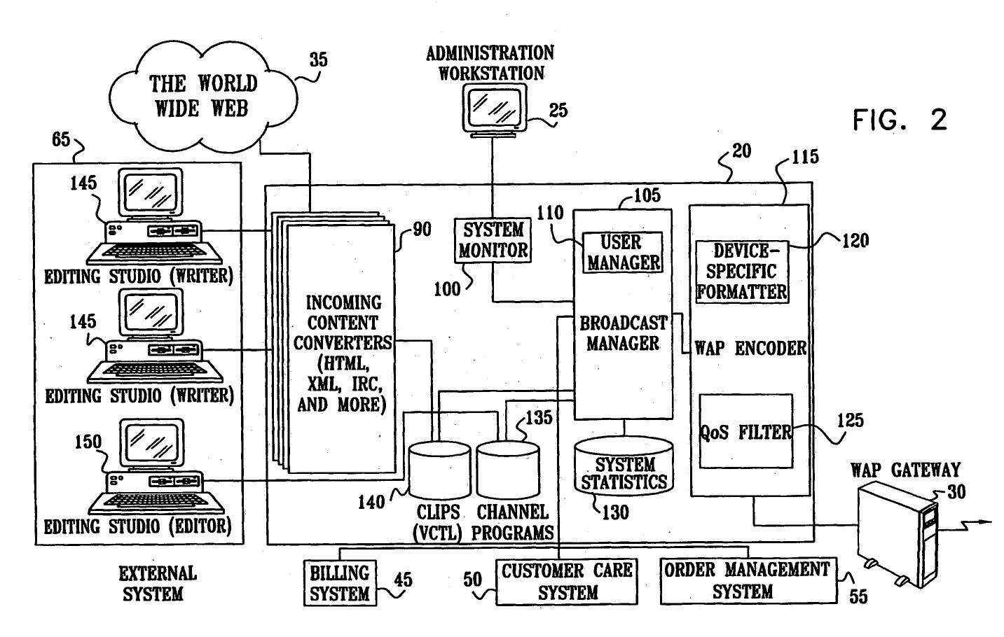

Further details of the components of server 20 are described hereinbelow with reference to FIG. 2.

Content channels are transmitted from server 20 via WAP gateway 30 to telephone 75 of user 70, at the request of the user. Channels can be deployed over any 2G network, such as GSM and CDMA networks, using a CSD connection. Packet IP networks such as GPRS are preferred, however, as they provide better service, such as “always on” functionality and more bandwidth to user 70. Transmission of content over mobile networks present service quality issues, mainly due to the fluctuating bandwidth as users move between cells and within the area of a given cell. These QoS issues are resolved, as described hereinbelow, by components residing within server 20 for handling these issues.

Bandwidth requirements depend on the nature of the channel, but are typically relatively modest. A simple text-based channel (for example, a joke or a news channel) uses approximately 3 kb per subscriber per minute, while a comics channel may require up to about 10 kb per minute. These bandwidths are still very low in comparison to the potential bandwidth of 108 kb per minute (1.8 kb per second) that is provided by a 14.4 Kbps connection. The modest bandwidth requirements are a result of unique content delivery technology, described hereinbelow, which preferably requires only a few short bursts of data transfer every minute. During the rest of the time, typically about 90% of each minute, the channel is alive on the handset but the air interface is available for serving other users and performing other tasks.

Server 20 preferably supplies a good quality of service even while working over low bandwidth networks. (Although cellular networks provide a potential bandwidth of 9.6 kbps per user, the actual bandwidth is generally lower). In accordance with a preferred embodiment of the present invention, server 20 senses and tracks the bandwidth of its link to each telephone 75, and adjusts the quality of service offered by the server based on the available bandwidth per user. While 9.6 kbps is not sufficient for rich media (full animations, video, etc.), server 20 can be adapted to offer channels with such rich media over high-speed networks.

In another preferred embodiment, server 20 utilizes push technology, under WAP 1.2.1, that allows server 20 to send content to client 75 even with no prior request from the client, allowing channels to be sent to a user 70 with no user intervention. WAP Push is similar to SMS, except that the content sent is a WAP link or application, rather than a simple text message. Additionally or alternatively, cellular data networks may feature multicast capabilities for content delivery. For instance, a bearer-level address may invoke a point-to-multipoint delivery in a wireless network, such as GPRS.

While server 20 can work as a standalone system, it is preferably integrated with at least some of the following ancillary systems: an advertising engine 40; a billing system 45; a customer care system 50; an order management system 55; a location-based server 60; and one or more editing studio workstations 65.

Advertising engine 40 typically stores and provides real-time advertisements, as are known in the art of Internet advertising. Server 20 receives the advertisements and inserts that, at appropriate locations in channels, are streamed to telephones 75. Preferably, placeholders (time fillers) are included in the channel contents provided to server 20 to indicate the points at which the advertisements are to be incorporated in the channels. Preferably, server 20 retrieves commercials from advertising engine 40 based on real-time attributes of each user 70, such as his or her geographic location, the selected channel, the kind of handset 75 being used, and possibly personal data such as the customer's purchase history, age, gender and the like, and general parameters such as the time of day and the weather. Integrating server 20 with advertising engine 40 allows a service provider to offer broadcast content mixed with embedded targeted ads and other kinds of personalized content, making the advertising seem like a natural part of the service.

While server 20 preferably broadcasts the same regular content to all users, in a further preferred embodiment, advertisements are personally targeted to user 70. This means that ads are not necessarily shared by all users 70 of the same channel.

Advertising engine 40 is preferably a full-function ad rotation and targeting engine, such as those used for Internet advertising. The ad engine preferably avoids excessive repetition of the same ad to the same user. In a preferred embodiment, advertising engine 40 may be offered by a third party vendor, and may comprise an ad engine provided by companies such as 24/7 Europe, Advertising.Com, and Ericsson.

Billing system 45 regulates the provisioning of pre-paid services and reports service usage. This system allows users to be charged for certain channel services provided by server 20, in addition to the air time charges that the users pay their cellular providers. IPDR billing records can be used to implement many different charging models for the channels, such as usage-based pricing (based on usage time or on the number of actual packets transferred), flat rate pricing, channel tiering (e.g., get six basic channels for free, pay a monthly fee for each additional channel), and so forth.

Customer care system (CRM system) 55, together with server 20, preferably provides personal customer data (e.g., the user's name, home location, known hobbies, age and gender) for channel applications, which allows parts of the broadcast streams to be replaced with localized, targeted, and personalized content.

Order management system 55 allows users to order products and services directly from a streaming advertisement in a channel. Preferably, users who have registered for this sort of on-line purchasing can place their orders by a single-click operation.

Location-based server 60 preferably allows server 20 to geographically localize and target content. Since the channels are broadcast to all users at the same time, the content of an individual channel is generally not varied according to a subscriber's specific location, with the possible exception of advertisements. Entire channels, however, can be localized such that the same channel broadcasts different content in different cities. For example, a “Time Out” channel (dedicated to movies, concerts, parties, etc.) can deliver different content based on the subscriber's location (meaning, a different channel for Paris and for London). A news channel can include location-based news clips with local news and weather reports that are relevant to a user's current geographic location.

Content editing studio 65 typically comprises software tools for manual channel editing allowing content providers to build their own program schedules (e.g., to create “prime time” slots and themed line-ups for the morning, evening, etc.) Details of the operation of studio 65 and sample content created by the studio are described further hereinbelow.

Reference is now made to FIG. 2, which is a block diagram that schematically shows details of content server 20, constructed and operative in accordance with a preferred embodiment of the present invention. Server 20 typically comprises several incoming content converters 90 which are a set of modules capable of processing different kinds of incoming content such as HTML and XML pages, and converting them into short clips that can then be transmitted in a channel. Some incoming content converters 90 are designed to receive content of various types prepared specifically for delivery by server 20 on content authoring stations 145 of editing studio 65. Converters 90 generate clips in a novel XML-based markup language, referred to herein as “VCTL,” which is described in detail hereinbelow. The processed clips are transferred to a clip database 140. Alternatively, editing studio 65 may format the clips directly in the appropriate VCTL format for a channel, in which case the channels are transferred directly to database 140. A scheduling station 150 creates channel programs, as described below, which define the sequence of clips and other content to be fed to each channel by server 20 at different times. These programs are stored in a channel program database 135.

Other converters are designed to automatically handle external content, for example from Internet 35, and to transform the content into VCTL. External content may include static sources of information (such as jokes or trivia databases), as well as dynamic information (for instance, Web sites with refreshing headline news). Dynamic content may be loaded in advance (every predefined interval) by special purpose processes run by server 20. The processes scan the designated sites for new content of a given type or format and then feed the content to the appropriate converter 90 for conversion into a VCTL clip. Once external content has been converted, it is preferably utilized in the same manner as originally-created content.

Incoming content converters 90 are preferably provided for converting information from external relational databases in any RDBMS format, as well as from Web sites in HTML format, news feeds from news agencies in unknown, formats, and chat rooms and user messages in various unknown formats. A Web page converter, for example, parses HTML pages and based on parameters configured for every site (such as URL, headline prefix, full story tag, etc.), reads and formats the required content from the page. Web crawling (reading content referred to by links) is preferably also supported.

As another example, chat rooms typically provide content suitable for channel display, as they contain short phrases of text. Obtaining content from a chat room can be performed by negotiating with IRC servers on Internet 35. User messages can include personal dating ads, requesting a concert ticket, etc. The message is broadcast to the channel viewers, and thus receives great exposure. These messages can be collected automatically in numerous formats such as SMS, e-mail, and Web forms.

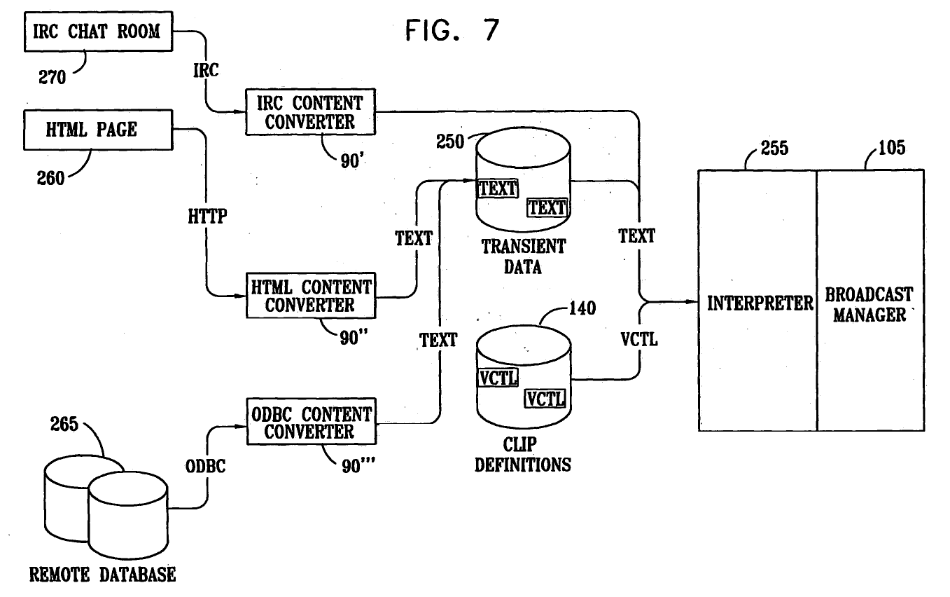

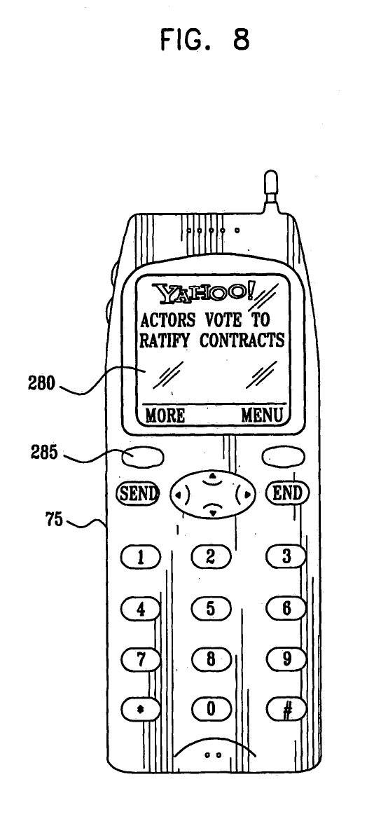

Further details of content conversion are provided hereinbelow, with particular reference to FIGS. 7 and 8.

Preferably, server 20 includes an API for use in designing converters to work with different content sources. The API is preferably implemented as a set of routines, along with a fixed file structure.

Server 20 also comprises a broadcast manager 105 that synchronizes among users 70, thus emulating a broadcast experience (since everybody gets the same content at the same time). The broadcast manager streams the content of each channel over call connections substantially simultaneously to all of telephones 75 that have selected the given channel at any given time. This feature allows the implementation of a broadcast service without requiring networks that support data multicast. Further details of preferred methods of synchronization between users are provided hereinbelow.

Broadcast manager 105 preferably comprises a user manager 110, for intercepting user events, such as keystrokes on telephones 75. The user manager thus supports implementation of interactive features in each channel. These interactive features enable the user to interrupt the broadcast flow of the channel on his or her own telephone 75 in order to select (or “zoom in” on) a particular link in order to obtain further information or purchase a product or service, for example. Further details of zoom-in features are provided hereinbelow.

Server 20 preferably also comprises a WAP encoder 115, which converts clips in database 140 from VCTL to WML pages in real time, as they are broadcast to users 70. Preferably, the WML pages are accompanied by WML scripts that determine how the streamed data are to be presented on telephones 75. Since current-generation WAP/WML microbrowsers support such scripts, there is no need to install a special-purpose client program on telephones 75.

WAP encoder 115 preferably also comprises subcomponents that format the clips specifically for the capabilities of each telephone 75 that is receiving a given channel at any given time. A device-specific formatter 120 determines the type of telephone and WAP microbrowser of each user 70 who is connected to the channel and converts the VCTL input to different WML code and scripts that are adjusted for the different user capabilities. For example, the WML code is preferably adjusted for the user's particular screen resolution. In addition, a QoS filter 125 allows the WML code to be adjusted for different QoS conditions, so as to ensure that the channel data are transferred to each user at a rate that is compatible with the available bandwidth. Further details of QoS filter 125 are provided hereinbelow.

Server 20 preferably also includes management features. Preferably, a system monitor 100 enables an operator at administration workstation 25 to monitor and control aspects of the operation of server 20. System statistics are maintained in a statistics database 130, which is accessible to the operator.

Channels

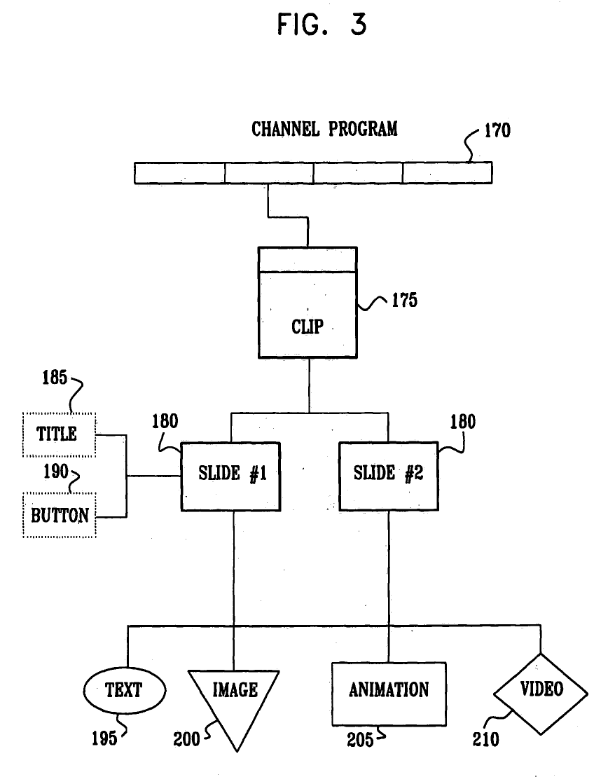

Reference is now made to FIG. 3, which is a schematic block diagram illustrating channel content elements, in accordance with a preferred embodiment of the present invention. A channel is the highest form in which server 20 broadcasts uninterrupted content. Unlike a Web site that is structured by spatial layout and hyperlinks, the channel program comprises a series of frames 170, which are arranged on a timeline as a stream of uninterrupted content A frame may include a clip 175, channel applications and ads. All users who are connected to a given channel receive the same series of frames at the same time.

Clip 175 is a channel item that delivers a complete piece of information, such as a news bulletin, a personal message, a comic strip, and so forth. A clip is usually relatively short, ranging from a few seconds up to a minute. Other than delivering information, a clip can also contain interactive actions such as “More” (to investigate an item further), “Call” (to initiate a phone call), “Link” (to go into a referred site), etc.

Channel programs database 135 (FIG. 2) preferably defines schedules for the channels. It typically contains all the information required by server 20 to perform the channel broadcast, including at least the following:

Item time frame: specifies the time and duration for item delivery.

Item type: clip, application or ad.

Item details: which clip or application, and possibly additional parameters (such as the product for sale in an instance of an on-line auction).

Other: marks for synchronization points (if required), tags for clip importance, etc.

A channel application is an item that has some degree of interactivity, and usually involves some level of multi-user connectivity. Examples of channel applications include, but are not limited to, auctions, surveys and trivia quizzes. The content of a channel application is typically broadcast to all users of a channel simultaneously (e.g., the item for sale in the auction, its current price, its qualities, etc.). The consequences of an action by one user, such as placing a higher bid in an auction, is transmitted to all other users, i.e. the other users see the current, higher bid for the item. An exemplary channel application is described in further detail below.

An ad (advertisement) is a channel item that is similar to a clip in all its attributes. However, it differs from a regular clip in that it delivers a different content to different viewers, based on targeting criteria. These criteria are typically provided by customer care system 50 and/or location-based server 60.

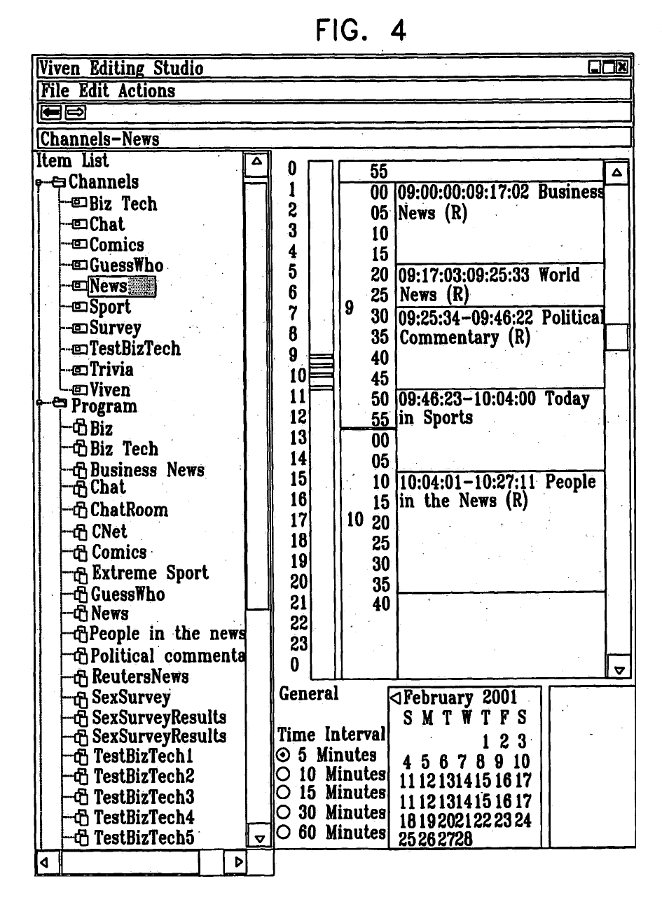

FIG. 4 is a screen shot of a graphic user interface used in creating a channel program, in accordance with a preferred embodiment of the present invention. The channel program defines the sequence, based on time slots, in which different clips, applications and ads are ordered. The channel contents are drawn from a news Web site on Internet 35 and are automatically converted into clips in database 140 by a converter 90. The program shown in FIG. 4 is created by scheduling station 150 and is stored in database 135, as described above.

Referring back to FIG. 3, each clip 175 comprises one or more slides 180, which together make up a frame that displays part of the clip's content for a few seconds. Sequential replacement of slides is one of the techniques to show streaming content.

Each slide 180 is composed of visual objects, such as, for example, text 195, an image 200, an animation 205, or a video sequence 210. Text objects 195 may be associated with a presentation effect that defines the manner in which the text is presented (e.g., blinking, fading in, etc.).

Additional optional content components of slides are a button 190, which defines a caption and an action for the phone (typically using one or more soft keys on the phone) and a title 185 that defines the headline of the slide. A combination of text and images with button and title creates a slide.

Slides are categorized into different types, and each slide type preferably has a predefined presentation layout. The presentation layout defines the combination between the various object types. For example, a possible slide layout can be as follows: aline of text at the top of the slide, and an image or an animation object at the bottom of the slide. Typically, the layout of a slide 180 is predefined, which simplifies the content creation process.

Channels can be created in numerous ways, either with or without the editing studio tools. A simple channel can be deployed by connecting its content source (e.g., an HTML page on Internet 35) to the appropriate converter 90 in server 20. From that moment on, server 20 preferably scans the page periodically, reads any new content that has been published, and converts it to clips. Another process in the server polls Web page or the clip database for new items and broadcasts them in the channel. Once a converter has been defined for a new content source, such as a Web page, the corresponding channel can stream indefinitely and will keep offering new content as it is published on the Web site. In addition, editing studio 65 allows content providers to add scheduling rules, thus assigning different kinds of content to different times of the day, as shown in FIG. 4.

As an example of the type of interactive channel content that may be created using studio 65, a “Dating and Mating” channel may offer, among other things, streaming personal ads sent by people who are looking for a date. As soon as a specific ad catches a user's eye, he or she can use one-click actions to initiate a voice call to the person behind the ad, send him or her a SMS message, save the ad in a personal mailbox, or forward it to a friend using SMS or an inter-user messaging facility. The channel may create its own database of ads or drawn on a set of HTML pages with such ads on Internet 35. A schedule of programs may be created as shown in Table 1 below:

TABLE 1
Sample Channel Schedule

| Time | Program | |
|---|---|---|
| 8:00 AM-9:30 AM | Men Looking for Women | Ads |
| 9:30 AM-10:00 AM | Men Looking for Women | Chat |
| 10:00 AM-11:30 AM | Women Looking for Men | Ads |
| 11:30 AM-12:00 PM | Women Looking for Men | Chat |
| 12:00 PM-2:00 PM | Anyone for Lunch? | Both |
| 2:00 PM-2:30 PM | Senior Citizen's Hour | Both |
| 3:00 PM-4:30 PM | Men Looking for Women | Ads |
| 4:30 PM-5:00 PM | Men Looking for Women | Chat |
| 5:00 PM-6:30 PM | Women Looking for Men | Ads |
| 6:30 PM-7:00 PM | Women Looking for Men | Chat |
| 7:00 PM-10:00 PM | Party Time - Will You Come with Me? | Both |
| 10:00 PM-12:00 AM | Teenager Time | Both |
| 12:00 AM-8:00 AM | Late Night and After Party Chat | Chat |

Users of such a channel would quickly become familiar with the schedule and would then tune in at the right time for their personal preferences, just as they would do in order not to miss their favorite radio and TV programs.

Clip Tag Language

A new tag language (VCTL) based on XML has been developed to allow content production that can be implemented across multiple platforms. This tag language enables a content producer to specify the data and the visuals of clips. That is, it provides means to define which slides are included in the clip, the text and images in each slide, etc., in a unified format that is used by WAP encoder 115 to create WML content for streaming to users 70. A DTD for VCTL is provided in Appendix A to this specification.

A clip represents a whole, single package of information sent to the user, and contains a number of slides identified by the tag <SLIDE>. The syntax of a clip is shown in Table 2.

TABLE 2
Clip Syntax

| Attribute | Mandatory | Default | Type | Explanation |
|---|---|---|---|---|
| ID | True | | String | Filename of the clip will be |
| | | | | sufficient as the clip id. |
| Alternative | False | “” | String | An alternate text to be sent |
| | | | | in case the client's band- |
| | | | | width is too small |
| | | | | to display the clip. |
| | | | | In case the |
| | | | | “Alt”attribute |
| | | | | is empty, a random |
| | | | | message will |
| | | | | be sent to the low band- |
| | | | | width clients. |
| ExtSource | False | “” | String | An external source name |
| | | | | (usually a database table |
| | | | | reference).This source will |
| | | | | be used when fetching and |
| | | | | and embedding external |
| | | | | data. Along the clip, |
| | | | | fields referring to the |
| | | | | external source may be |
| | | | | embedded. The syntax of |
| | | | | an embedded field is |
| | | | | $(FieldName). |
| | | | | This value will be replaced |
| | | | | with the value from the |
| | | | | corresponding field of the |
| | | | | external source. |
| Where | False | “” | String | A “where” clause for |
| | | | | selection of |
| | | | | rows from the external |
| | | | | source. |
| Bandwidth | False | LOW | Enum | Bandwidth limitation of the |
| | | | | clip. |

An example of XML code for a clip is:

```
<CLIP ID=“Dilbert2” ExtSource=“ComicChannel”
    Alt=“There are currently $(ViewersNumber) viewers in channel
        $(ChannelName)” Bandwidth=HIGH>
            <SLIDE>
            </SLIDE>
        </CLIP>
```

A Slide represents a frame that displays part of the clip's content. A slide tag corresponds to a specific layout of a slide. A slide preferably contains at least one of the following elements: <TEXT>, <IMG>, <FONT>, and <GRAPH>. The syntax of a slide is shown in Table 3.

TABLE 3
Slide Syntax

| Attribute | Mandatory | Default | Type | Explanation |
|---|---|---|---|---|
| Layout | True | | String | The name of a layout that |
| | | | | will be generated for this |
| | | | | for this slide. Layouts |
| | | | | define the looks of the slide |
| | | | | (where texts are located, |
| | | | | where images are located |
| | | | | etc.) |
| Title | False | “” | String | This is the title of the slide. |
| | | | | If the WAP device has |
| | | | | card title, this would be it. |

An example of XML code for a slide is:

<CLIP>

<SLIDE
layout=“ComicsLayout” title=“Dilbert Comics” timeout=“5”>
</SLIDE>

</CLIP>

Available layouts for slides preferably include:

TextOnly: Slide contains text with no images.

ImageOnly: Slide contains image with no text.

HeaderText: Slide contains text above an image.

FooterText: Slide contains text below an image.

These layouts are listed by way of example, and other layouts (such as the above-mentioned “ComicsLayout”) may also be defined.

Text tags describe text. Each layout defines its own possible text fields. The text tag holds the text to display, how it is going to be displayed, and where in the layout it will be displayed. Typically a text tag does not contain any other elements. Preferred syntax for a text tag is shown in Table 4.

TABLE 4
Text syntax

| Attribute | Mandatory | Default | Type | Explanation |
|---|---|---|---|---|
| Effect | False | None | Enum | Name of the requested eff- |
| | | | | ect. Not specifying the |
| | | | | effect means displaying |
| | | | | static text. |
| Field | True | None | String | The field name in the layout |
| | | | | where the text will be |
| | | | | inserted. The field must |
| | | | | exist in the slide layout, |
| | | | | and |
| | | | | must be a text field. |

An example of XML code for a text tag is:

<TEXT Effect=“Lines” Field=“Txt1”>

Today's Headlines: $(Headlines)

</TEXT>

Available text effects preferably include:

Blink: Simple blinking of the text

SpaceInvade: Text moves from left to right and back in a loop

LasVegas: Every second letter blinks

TickerLeft: Text enters the display from the left

TickerRight: Text enters the display from the right

WordByWord: Text is displayed word by word

LetterByLetter: Text is displayed letter by letter

Lines: Text is displayed line by line

Starwars: Text scrolls from the bottom of the screen upwards

Image tags describe images. Each layout defines its own possible image fields. The image tags hold the image to display. Images are displayed according to the end-user device capabilities. Typically an image tag does not contain any other elements. Preferred syntax for an image tag is shown in Table 5.

TABLE 5
Image Syntax

| Attribute | Mandatory | Default | Type | Explanation |
|---|---|---|---|---|
| Alt | True | “image” | String | Alternative text to display |
| | | | | instead of an image. |
| Src | True | “” | String | Image logical source file |
| | | | | name (logical means that |
| | | | | the server will determine |
| | | | | from where to take the |
| | | | | real image, according to the |
| | | | | end-user device and |
| | | | | bandwidth). |
| Field | True | None | String | The field name in the |
| | | | | layout where |
| | | | | the image will |
| | | | | be inserted. The field |
| | | | | must exist in the slide |
| | | | | layout, and must be an |
| | | | | image field. |

An example of XML code for an image tag is:

<IMG src=“sun.wbmp” alt=“sun” Field=“Image2”/>

Font tags describe images that are generated dynamically and display texts in special fonts. Fonts are displayed in image fields of the slide layout. The font tags hold the text to display and the font style. Fonts are displayed according to the end-user device capabilities. Typically a font tag does not contain any other elements. Preferred syntax for a font tag is shown in Table 6.

TABLE 6
Font Syntax

| Attribute | Mandatory | Default | Type | Explanation |
|---|---|---|---|---|
| Text | True | “” | String | The text to be generated for |
| | | | | FONT images. |
| Alt | True | “” | String | Alternative text to display |
| | | | | instead of the font |
| | | | | image. |
| Size | False | | Integer | Font size. |
| Name | False | | String | Font name. |
| Style | False | | String | Font style (underlined, |
| | | | | bolded, italics). |
| Field | True | None | String | The field name in the |
| | | | | layout where the font image |
| | | | | will be inserted. The field |
| | | | | must exist in the slide |
| | | | | layout, and must be an image |
| | | | | field. |

An example of XML code for a font tag is:

<FONT Text=“Hello!” Alt=“Hello!” Size=16 Name=“Arial” Field=“Image2”/>

Graph tags describe images that are generated dynamically and display graphs of values. Graphs are displayed in image fields of the slide layout. The graph tags hold the values of the graph, the style of the graph and the looks of the graph. Graphs are displayed according to the end user device capabilities device capabilities. Typically a graph tag does not contain any other elements. Preferred syntax for a graph tag is shown in Table 7.

TABLE 7
Graph Syntax

| Attribute | Mandatory | Default | Type | Explanation |
|---|---|---|---|---|
| Alternative | True | “” | String | Alternative text to |
| | | | | display instead of the |
| | | | | graph. |
| Title | False | “” | String | Graph title that will be |
| | | | | displayed in the graph |
| | | | | image. |
| Style | False | Enum | BAR | BAR, LINE, PIE |
| Display Values | False | False | Boolean | Whether to display the |
| | | | | values |
| DisplayNames | False | False | Boolean | Whether to display the |
| | | | | value names on the |
| | | | | graph. |
| ValueList | True | | String | A list of values in the |
| | | | | format “Value |
| | | | | ValueName, Value, |
| | | | | ValueName”. For ex- |
| | | | | ample, a list of survey |
| | | | | results may look like |
| | | | | this: “53 Yes, 47 No”. |
| Field | True | None | String | The field name in the |
| | | | | layout where the graph |
| | | | | image will be inserted. |
| | | | | The field must exist |
| | | | | in the slide layout, and |
| | | | | must be an image |
| | | | | field. |

An example of XML code for a graph tag is:

<GRAPH Alt=“Survey Results” Title=“Results” DisplayNames=TRUE ValueList=“$(SurveryResults)” Field=“Image2”/>

A button tag provides the ability to the user to interact with the clip, by pressing on the default softkey of telephone 75. Typically a button tag does not contain any other elements. Preferred syntax for a button tag is shown in Table 8.

TABLE 8
Button Syntax

| Attribute | Mandatory | Default | Type | Explanation |
|---|---|---|---|---|
| Type | True | | String | Buy, Zap, Link, Save, |
| | | | | Forward, More, Dis- |
| | | | | connect |
| Caption | True | | String | Title of the button |
| Parameters | False | “” | String | Parameters field. This field |
| | | | | contains parameters for |
| | | | | the action to be |
| | | | | performed. For example, in |
| | | | | the “More” button, the |
| | | | | “parameters” attribute |
| | | | | contains the text of the |
| | | | | “More”slide. |

An example of a button tag is:

<BUTTON type=“buy” caption=“Buy!“parameters””>

Button tags enable users to access interactive “zoom-in” features offered by the channel, as described further hereinbelow.

An example of VCTL code is:

<CLIP ExtSource=“NewsTable” bandwidth=LOW>
<SLIDE title=“Mideast News” timeout=“5” layout=“TextOnly”>

<TEXT fieldname=“txt1”>
$(Headline)
</TEXT>
<BUTTON type=“more” caption=“More”
parameters=“$(FullStory)”/>

</SLIDE>
</CLIP>

Channel Applications

Channel applications typically have a higher degree of interactivity than clips, and usually involve multi-user connectivity. There are a number of constraints involved in developing applications, including i) wireless networks suffer from high latency and low bandwidth relative to wired Internet networks; ii) many WAP-enabled devices have display limitations such as small screen size and lack of color resolution; iii) the processing power of many client devices is weak with very limited communications support. Additionally, the absence of Java-like language and multithreading support means that an exchange between a wireless device and the server blocks execution of the application on the device.

Some of these restrictions (such as the small screen size) are overcome using the visual effects and layouts described herein. The above constraints may require development of applications that do not heavily burden the processing power of the device, and that do not rely on high-speed network requirements. Applications that are most suited are applications that do not involve real-time synchronization between users. Further details regarding the design of multi-user applications for the WAP platform are given in “Mobile Entertainment Service: Developers Guide,” (Nokia, May 2000) and “The Basics of WAP Game Design,” (E. Wells, April 2000, as mentioned in the Background of the Invention.

Applications may be designed for either a single-user or multiple users. A multi-user application typically involves some level of interaction, or synchronization, between users. For example, a chess game played against a second user is a multi-user application since the actions of one party influences the status and actions of the other party. A trivia quiz, however, is typically a single-user application as a user's actions do not affect the actions of a second party, even if multiple users are competing against each other.

In a multi-user application the number of users can be either strictly defined (e.g., two users for chess game), or open to multiple users (as in a bingo game, or an auction).

Some applications may require that participants be arranged into groups, particularly when the number of users in the application is strictly defined. Grouping may be required in an application where a group of users compete against another group. Alternatively, an application may optionally divide users into many groups in order to simplify the application processing, and to create a user-friendly environment for the participants.

Inter-user synchronization can be either real-time or turn-based. A real-time application, such as a multi-player Quake game, typically requires a high level of synchronization between users, in which an action performed by one user is preferably presented to the other users immediately. Turn-based synchronization means that the application order follows a regular structure in which the users sequentially take turns at using the application, i.e. the application timeframe is divided into rounds. Many games are turn-based, such as trivia quiz, chess and other board games. In each round, a single player is involved, and hence the synchronization between users can be performed at the end of each round. In alternative turn-based applications, all the users participate in the round, and synchronization between them occurs when the round ends.

Applications may be fragmented or continuous. Continuous applications typically include games that are continuously broadcast throughout their duration. Fragmented applications may be delivered intermittently, interspersed with other content. For example, a survey can have two distinct parts that are broadcast separately: the questions are delivered in the morning and the results later in the evening.

Applications may have fixed or flexible starting points. Applications like chess require all users to attend when they start. Others, like auctions, allow users to join the application whenever they want.

Some applications, such as board games, can be stopped by the user or users, saved, and resumed at a later date, after being restored.

Applications may end with a result such a defined winner or scores. Some applications may utilize cumulative scoring (or credit points). Alternatively, scoring may be measured against other users (e.g. high scoring tables).

Some applications, such as a trivia quiz, receive content, such as questions and answers, from external sources. Other applications, like a chess game, do not need external content sources.

Preferred characteristics of a variety of applications to be provided by server 20 are provided in Table 9. These characteristics take advantage of the broadcast, time-based nature of the content provided by the server, while minimizing weaknesses due to low bandwidth and other shortcomings of mobile communications. While the characteristics shown in the table are preferred, for a variety of reasons, it should be understood that other applications, not according with these preferences, may also be supported by server 20.

TABLE 9
Preferred Application Characteristics

| Characteristic | Value | Remarks |
|---|---|---|
| User Mode | Multi-user | Single-user applications do not leverage |
| | | the broadcast power of server 20. |
| Number of Users | Open | Anyone can join at any moment, or wait |
| | | up briefly for the next round to |
| | | start. |
| User Groups | Possibly | Only if performed automatically, in |
| | grouped | order to simplify the application |
| | | processing. |
| Users | Turn-based | Due to the fundamental limitations of |
| Synchronization | | the current WAP platform. |
| Sequence | Fragmented/ | Both modes are possible for channel |
| | Continuous | applications. |
| Starting Point | Flexible | A user is not required to attend the |
| | | starting point of the application in |
| | | order to participate. |
| Persistent Status | No | Channel applications execution is not |
| | | controlled by the user. Thus, |
| | | the application can not be |
| | | stopped by the user in |
| | | order to save and restore later. |
| Persistent Results | Support if | Application results could be saved by |
| | required | the channel application. |
| External Content | Usually | Most channel applications will require |
| Sources | Required | the use of external content sources. |

A wide range of different interactive channel applications may be supported by server 20. Exemplary applications include commerce and auctions, trivia and word games, gambling, and opinion polls. An enumeration of all of the possible applications is beyond the scope of the present patent application.

Preferably, the content prepared for channel applications is designed to match the screen size. The minimal screen size requirement for channel applications is typically 4 lines by 15 characters. Additionally, as some devices support titles, while others do not, one cannot assume that a title is available. Therefore, applications are preferably specified without the title line. Alternatively, the title line is used on devices that provide this feature in-order to enrich the content delivered for the user.

The content of an application can be displayed in various formats. For example, survey results can be displayed in pie charts, vertical bar charts, graphs etc. In another example, details of-items for sale can be delivered to a user using various effects, such as a ticker, scrolling lines, etc. The VCTL Clip Tag Language, as described above, is preferably used for specifying the format of the application.

Channel applications typically differ from clips in that the duration of an application may, at least partially, depend upon a user's responses. For example, the pace of answering survey questions may differ among users. (Some answer questions quickly, while others wait or do not answer at all). Also, some trivia games could end faster than expected if the players are trivia experts. When an application finishes more quickly than predicted, and there is a need to synchronize between users, an application may be made to last longer that the time it actually takes by using a filler. Fillers, such as text or animation clips, can be used to make channel application last for the same duration for all of the viewers, and to fill additional time for applications that ended faster than planned. Alternatively, channel applications end after a specified time interval has elapsed, whether or not the user responded and regardless of how quickly the response was received.

Preferably, user information stored by customer care system 50 and/or order management system 55 (FIG. 1) is used in tracking user participation in channel applications, and particularly in enabling consumers to purchase goods and services. Alternatively, some applications may not require user registration, and users can participate in them as guests. System 50 or system 55 may also be configured to enable advanced users to keep their scores in games, and track their participation in applications over time.

Preferably, if a user's session with server 20 was disconnected while the user was participating in an application, and then resumed, her status in the application is seamlessly resumed. The importance of successful recovery varies between applications, based on the potential damage to the user in case of an unsuccessful recovery. For example, a user's auction bid must be reserved even if her device was suddenly turned off. To a lesser degree, recovery is also important for games: keeping the player's last score, for example. In some applications, the recovery procedure is almost insignificant. In a survey, for example, the damage caused due to disconnection is simply the need to ask the user to reanswer some of the questions.

Under the currently-defined WAP standard, there is no unique identifier for the user that can be used in all environments for recovery following disconnection. Therefore, in some cases, manual procedures (requiring the user to reenter some information) may be necessary when seamless automatic recovery cannot be performed.

An example of a survey application is now described by way of example. A survey queries a group of people in order to obtain opinions about some topic. Each person participating in the survey is asked to answer one or more questions, which answers are gathered from all participants and analyzed to provide the results of the survey. Typically, the survey results are also broadcast over the same channel. Such surveys are potentially powerful since they may involve a large number of users.

A survey is typically a multi-user application, that does not require multi-user synchronization. While a survey is not a real-time or a turn-based application in the standard sense, it does have turns in which different questions are presented to the same user. The number of participants in a survey is not limited or defined: A survey can contain more than one question on the same topic. A survey does not require grouping the users. Typically, the presentation sequence of a survey may be fragmented in that the results are not necessarily displayed immediately after the questions, resulting in a survey having two distinct parts, one for querying and one for displaying results. The survey may be repeated to allow more people to answer the questions or view the results. A participant in a survey can answer all the questions, some of them, or none. A survey does not have a fixed starting point, in that a user can answer survey questions without answering the first question. Preferably, a user will not be asked to answer the same question more than once.

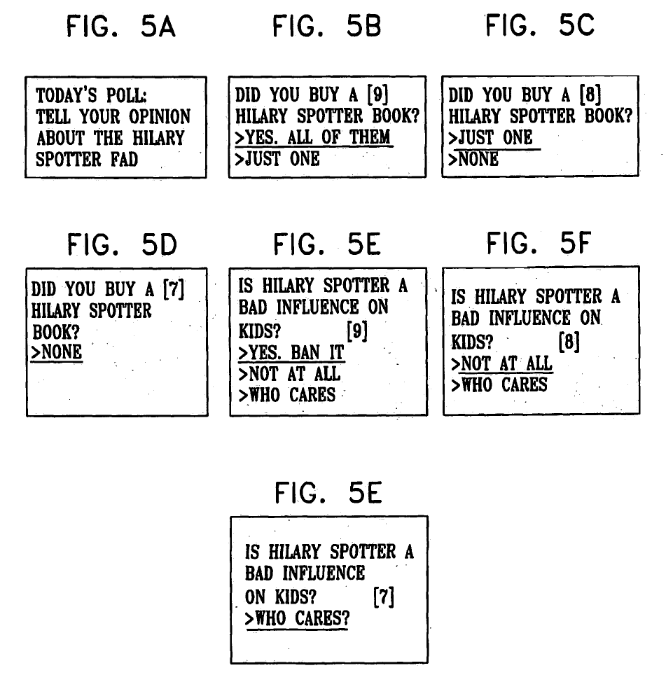

Reference is now made to FIGS. 5A-5G, which are a series of screens from a query phase of a survey, in accordance with a preferred embodiment of the present invention. Each screen displaying one multiple-choice question and its possible answers. Typically, each screen also includes the amount of time (in seconds) remaining in which to answer this question. When the time is up, or the person answered the question, the next screen, with the following question, is displayed.

FIG. 5A is a preview screen displaying the topic of the current survey. Shown in FIGS. 5B-5D, the first question is then displayed, with the possible answers scrolled at the bottom of the screen, allowing more questions than the lines available. Typically a user clicks on the soft key of the device in order to select the highlighted answer in a one-click action. After the allotted time for the first question expires, or the question was answered, the next question is displayed, as shown in FIGS. 5E-5G, with the possible answers scrolled at the bottom of the screen.

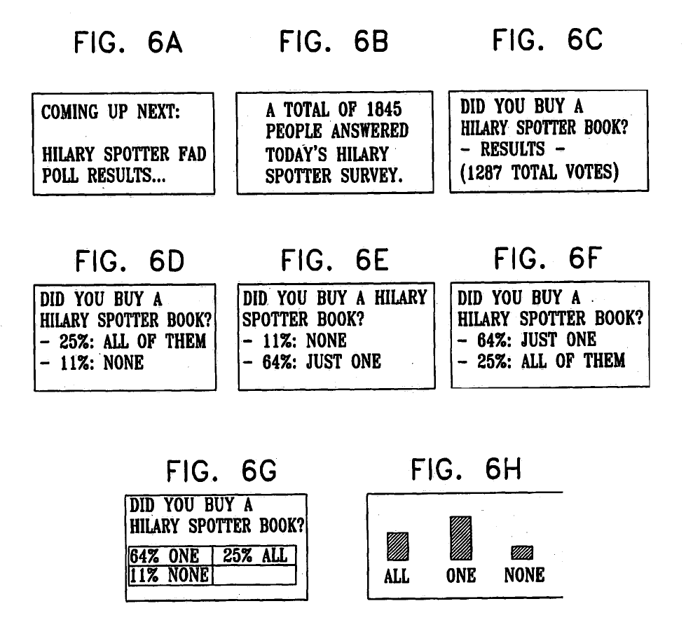

Reference is now made to FIGS. 6A-6H, which are a series of screens from a results phase of the survey of FIGS. 5A-5G, in accordance with a preferred embodiment of the present invention. The results phase is typically composed of a few screens, each of which displays the results of one question. The results for each question can appear in more than one screen format. After the results of a question have been displayed for a specified duration, the results of the next question are usually displayed.

FIGS. 6A-B are optional preview screens preceding the results. FIGS. 6C-6H are screens showing the number of total votes received for the question, and the results of the survey, displayed in several formats including scrolling lines (6D-6F), table (6G), and a graph (6H).

Interactive Controls

The channel applications described above involve interactive features. In contrast to clip 175 (FIG. 3), such applications allow or require user 70 to respond to the content displayed on telephone 75. Preferably, the interaction is simple in nature: one click on a button on the telephone performs a single action. When the user clicks on the button, WAP gateway 30 receives a signal from telephone 75, and accordingly generates an event message to server 20. User manager 110 captures this event and identifies the user to whom it pertains and the channel that the user is presently receiving. Based on this information, the user manager is able to invoke the appropriate interactive feature, as described below.

In many cases, telephone devices only have one button available for interaction, so that practically speaking, only one action is associated with each slide. Such single-button operation is a limitation of the current WAP protocol and available cellular telephone devices. In future-generation devices, richer user controls can be exploited.

The following are non-limiting examples of possible interactive features that can be associated with a channel: “Link”; “More”, “Call”; Save”; “Forward”; “Buy”; “Chat”; and “Zap”.

Link: switches to a Web site via a URL that is related to the slide. This can be, for example, a referral to a sponsoring site, or simply to a site providing details about the topic presented in the current slide. Linking typically causes the user to exit from the channels provided by server 20 and their streaming content mode into the fully interactive environment of the Web, accessed via WAP gateway 30.

More: provides additional information on an item related to the current slide. This option is particularly useful for a news channel. While viewing a clip of news headline, the “More” feature can provide the full story.

As opposed to “Link,” which takes a user out of the channels to a Web site, the information displayed using the “More” feature is preferably delivered by server 20. Controlling the additional information via server 20 allows the user to exit from the channel temporarily and to return to the channel by pressing a “Back” button (e.g., after reading the full story). Additionally or alternatively, a timeout interval can be specified by the content editor or the user, after which the channel automatically resumes. The timeout interval is preferred when telephone 75 does not have a separate Back button.

Call: initiates a phone call to a number which is typically supplied by the content provider. Initiating a phone call typically causes telephone 75 to exit from the channel. Depending upon the client device and the network bearer, initiating a phone call may disconnect data transfer altogether. For example, if the channel is an adult channel, the “call” feature is especially useful for answering a personal ad, or connecting to an advertiser's call center. Preferably, this feature takes advantage of telephony support offered by many microbrowsers.

Save: stores the current item in a personal folder on or associated with server 20. Preferably, upon use of the “save” feature, a notification message indicating the item was saved pop-ups for a short time on telephone 75, preferably about 2 seconds, after which the channel execution is resumed. This feature is particularly useful for storing an item (such as recipes, beauty tips, etc.), for careful study later, or for sending them to a friend.

Forward: sends an item to a friend (or friends). Channel execution is resumed after sending. One may send a clip to a friend who is not a subscriber to server 20 (e.g., by means of SMS) or to another subscriber directly to his personal folder. This feature typically involves managing folders and contact lists (possibly via integration with an instant-messaging product), as is known in the art.

Buy/Order: starts an m-commerce transaction. In one preferred embodiment, the transaction is performed by switching to a commerce-specific interactive application, which takes the user out of the streaming channels. For example, while watching a book commercial, one can ask to buy that specific book. The “Buy” feature switches the user to an application that handles book orders. Alternatively, the purchasing interaction may be performed directly by server 20.

Transport of information between the client and the server is preferably secured, especially during mobile commerce applications, using methods known in the art which are typically based upon data encoding and encryption. For example, the WAP platform features WTLS to provide secured transport between telephone 75 and WAP gateway 30.

Chat: sends SMS, e-mail or enters an instant messaging application. The chat feature is useful, for example, in responding to personal ads. Channel viewing is suspended while preparing an sending the message, and is resumed after the message is sent.

Zap: switches to another channel. Can be used for internal promotions. For example, while watching the Sports channel, an item tells the viewer what is currently on the Lifestyle channel. The Zap button allows the user to immediately switch to that channel.

User Interface

Designing a user interface to provide such interactive features on a handheld devices is a difficult task. The displays are small, the input devices (e.g., the phone keypads) are small, too, and there is a huge diversity among devices from different vendors. Since the keypad of many devices is limited, adding features increases the complexity of performing these operations. A channel user interface preferably supports the following operations:

“Action”: one button (soft key) is reserved for interactive operation on a given clip or application. This button enables one-click operation for a predetermined action related to the information displayed (Link, Call, More, etc.).

Alternatively, one button is used for all-purpose functionality. One-click on this button gives the user a list of possible operations for selection, which includes all actions relevant at that point such as channel zapping, clip action (Link, Call, More, etc.), and other advanced options (setting personal preferences, viewing messages, exiting channels, etc.) The user scrolls through the options and then selects the desired option.

Zap: channel zapping is performed by either pressing the Up/Down buttons, or pressing a special “Zap” button and then a channel number.

Exit: exiting the channel viewing mode is performed by one-click on the Exit button.

TABLE 10
User Interface Controls

| Soft Keys | |
|---|---|
| 1 | Options - switches to a menu displaying all relevant |
| | actions including: associated action (if exists), channel |
| | zapping, exit, and any other advanced options. |
| 2 | Options - same as above, excluding associated action. |
| | Action - performs associated action. |
| 3 | Options - same as above, excluding associated action |
| | and channel zapping. |
| | Action - performs associated action. |
| | Zap - select channels from a list, and/or by entering |
| | channel number. |
| 4 | Options - same as above, excluding associated action |
| | and channel zapping. |
| | Action - performs associated action. |
| | Zap - select channels from a list, and/or by entering |
| | channel number. |
| | Exit - exit channels. |
| Up/Down | If available (in addition to at least one more soft key), |
| | handles channel zapping. |

Response time requirements differ according to the operation performed by the user, and may be divided into at least the following categories:

Next Item Streaming: When viewing a channel, a user processes the information provided, and therefore the pace of replacement of items can be somewhat relaxed (i.e. the user is still contemplating the preceding item before seeing the next one). Still, the interval between two items on the same channel preferably does not exceed 4 seconds. (This interval typically does not include the time specified by the content editor as duration between items.)

Visual Effects: The speed depends on the effects: Line effect are usually slower than one-character effects. As revealing a text gradually can be annoying to a user, the effect speed is typically faster than 1 second.

Action (More, Link, Call, etc.): Pressing an action button is preferably responded to within 4 seconds. Further preferably, some indication, such as an hour glass, is provided in order to inform the user that the action request is being dealt with. Alternatively, when possible, the response can be substantially immediate.

Zapping: switching between channels is preferably faster than “next item streaming”. Preferably, channel zapping does not exceed 2 seconds.

In cases when the desired response times for streaming and channel zapping cannot be achieved, a pre-loaded default clip (such as, “please wait while . . . ”) can be displayed.

Broadcasting

The limitations of standard telephone devices does not easily enable a broadcast technology as provided by server 20. In the absence of a proprietary client installed on telephone 75, server 20 cannot simply broadcast content to its clients. Instead, the microbrowser on telephone 75 sends WAP requests to server 20, which responds by sending content to the client which is translated to a clip display on the telephone. When one clip display is terminated, the client requests that server 20 deliver the next clip. A broadcast channel is built of a plurality of individual clips delivered in sequence, with the same clip delivered to all the viewers at the same time.

In order to deliver the same clip to all users, a synchronization mechanism between users is employed. The synchronization performed by the server preferably takes into account several environmental variables that affect the transmission process. For instance, the bandwidth available for each user and the processing speed of its device are some of the factors that may influence the delivery of items. Therefore, server 20 synchronizes delivery of content to users when processing a request, in a manner that takes into consideration the content delivery time for every user.

Typically, based upon the type of the content, different levels of synchronization are employed. Applications generally require the highest level of synchronization. For example, in an online auction, when a user bids on an item, other users must be aware of it. Similarly, when a question is asked in a trivia game, all players must receive the question at the same time. Some margin is allowed in the synchronization of the delivery of clips to multiple users. A short interval of up to about 30 seconds of item delivery between users can be accepted. However, intervals preferably should not increase as the server continues to deliver items.

Apparent synchronization can be effected using redundant clips. For example, in a news charnel, headlines may be delivered as a sequence of headline news clips, each one delivering a different headline. To achieve synchronization, a user may only receive a subset of the headline clips. A user suffering from a narrow bandwidth, can be synchronized with users having a better bandwidth, by receiving different content from these other users. This could include receiving fewer of the redundant clips, or the same number of clips but each having a “lighter” content. Additionally, or alternatively, when a user suffers from a serious network disruption, only some of the content may be delivered.

When laying out a channel timetable, a channel editor may wish to schedule specific events at suitable times. An event can be, for example, the launching of an application or the beginning of a news program (delivering news headlines on the hour). This allows the content provider to define an exact timetable (e.g., saying that news headlines are broadcast every hour, on the hour). A sample schedule is shown above in FIG. 4. Since viewers of the channels are not totally synchronized (some margins are allowed), this feature may require defining synchronization points for the channel viewers. So, when the time for a synchronized broadcast arrives (marked by a synchronization point), the server takes special care in tuning all users to the same content.

As noted above, content delivery to a wireless device is error-prone due to device mobility and the general instability of wireless networks, and disconnections are frequent. After a disconnection, some microbrowsers try to recover by reconnecting and sending the last URL request. Others devices simply shut down the microbrowser. Even the IP address of a user may change during a (logical) session if the device disconnected, and the microbrowser seamlessly recovered. Preferably, the user recovery process is as transparent as possible. In general, this means that the telephone should return to the status that existed prior to the session failure:

If a user becomes disconnected during standard channel viewing, upon reconnection, the user preferably receives the channel she was watching before. The item delivered upon reconnection is typically the item currently broadcast on that channel.

If a user becomes disconnected when browsing through a “More” (information) feature, upon reconnection, the user preferably receives the same item she was viewing (rather than automatically re-entering the channel mode).

If a user becomes disconnected while using an application, upon reconnection, the user preferably returns to the same state as before (e.g., recovers her score in a game she was playing). The information display must change according to what happened so far in the application.

Pre-Loading Images

In order to allow seamless appearance of images on telephone 75 subject to the low bandwidth that is generally available, images are preferably pre-loaded to the telephone's cache memory before actually showing them. Then, when the image is requested, it is taken from cache and thus appears immediately. This requires that the images be loaded prior to their actual use by preceding clips or slides in the same channel.

Image pre-loading is preferably transparent to the content producer, using an automatic mechanism for pre-loading content. Alternatively, software wizards can be provided within editing studio 65 to enable the content editor (in creating a comic strip, for example) to invoke the pre-loading code without including a specific instruction in the content.

Bandwidth Fluctuation

The available bandwidth for each user over a wireless network is volatile, and may change during a session. This affects, for example, the time required for loading images. QoS filter 125 (FIG. 2) preferably keeps track of-the effective bandwidth available per user, and instructs broadcast manager 105 to modify the content sent to each user accordingly. Although the cellular network over which server 20 broadcasts to telephones 75 typically tracks its own QoS, this information is generally not available to content providers in any readily-usable form.

One method of determining the quality of service between server 20 and a particular telephone 75 is measuring the round-trip time required for a message exchange between the server and the telephone. This type of round-trip measurement is known in the art of communication networks as a “ping” test. Although ping is used in various network testing applications, it has not been used up to now for modifying the content sent from a server to a client. In the context of the present invention, the time taken for the signal to travel from server:client:server is directly related to the bandwidth available. The measured time thus enables server 20 to estimate the available bandwidth and to adjust its content accordingly, without relying on the cellular network to provide this information.

Server 20 preferably modifies the delivered content based on the measured bandwidth in at least one of the following manners:

Altering the amount of time specified for image pre-loading according to available bandwidth.

Delivering content adjusted to the available bandwidth. For example, if the available bandwidth is high, larger or more detailed images may be sent. Conversely, with a lower bandwidth, less data-intensive content may be sent, such as smaller images, text only, text with no effects, etc.

Discarding specific content due to the time required to deliver it (correlated to maintain channel synchronization).

The VCTL format of the clips allows WAP encoder 115 to prepare the WML pages and scripts sent to telephones 75 on the fly in multiple different versions, each adjusted for the particular bandwidth and device capabilities of the individual telephone and microbrowser.

The QoS (average response time, effective bandwidth, etc.) is preferably made available to the content editor in order to report it to the user if appropriate.

Content Conversion

Automatic channels typically comprise continually updated content from an external source and converted into the appropriate clip format for broadcast to mobile subscribers. Automatic channels require relatively minimal effort in both initial set-up and maintenance. Content providers routinely publish and update their content, and an automated process converts it into broadcast format. Optionally, the content provided by the content provider may be enhanced by manual editing.

Reference is now made to FIG. 7 which is a block diagram that schematically shows details of apparatus for content conversion, constructed and operative in accordance with a preferred embodiment of the present invention. Content for an automatic channel is typically acquired by a content converter 90 such as IRC converter 90′, HTML converter 90″ and a relational database (ODBC) converter 90′″.

In a preferred embodiment, converting content is a two-phase process. One of content converters 90 reads updated content in a specific format and stores it as plain text in a transient data database 250. Then an interpreter 255 reads the updated text and formats it as a clip using one of the VCTL templates stored in the clip database 140. The VCTL templates determine the look-and-feel of the clips, the duration they will appear on the screen, and the interactive options attached to them.

Once the Interpreter finishes embedding the text into the VCTL template, the clip is ready to be broadcast in the channel. Broadcast manager 105 transmits the clip, to all the users of the channel, via an encoder such as WAP encoder 115 of FIG. 2.

Incoming data such as from an HTML page 260 or a remote database 265 is typically stored in transient data database 250 before conversion into clips. An exception is data from an IRC chat room 270 which, for performance reasons, is preferably pushed directly to the interpreter 255 rather than stored in the database 250.

By way of example, content conversion from an HTML page 260 to a channel clip is now described. An HTML page from, for example, the “Yahoo!”™ portal contains news stories in the form of a short headline, a story synopsis, and a link to the complete story. In the forthcoming example, for the sake of simplicity, the link to obtain “full coverage” on the HTML page 260 will be ignored and the synopsis will be treated as if it were the full story.

HTML converter 90″ is scheduled (typically using an external scheduler) to periodically read the updated headlines from Web page 260. During system installation, HTML content converter 90″ receives parameters such as the Web page URL, the location of the headline within the page, and the location of the synopsis relative to the headline.

Initialization parameters for an HTML converter for grabbing Yahoo! news stories can be as follows:

[YahooBizAP]

URL=http://dailynews.yahoo.com/h/bs/ap/

TagName=a

AttributeName=

AttributeValue=

InnerText=Symbol Lookup

EachTagName=b

EndTag=hr

EndText=Earlier Stories

FindPosition=1

SubFindPosition=2

Using these parameters, HTML converter 90″ can identify and acquire the relevant parts of Web page 260. The headlines and stories taken from Web page 260 by HTML converter 90″ are written to transient data database 250 and stored as plain text. Table 11 contains a sample of text stored in a transient data table:

TABLE 11
Text stored in a Transient Data Table

| Headline | Story |
|---|---|
| Actors Vote To | Rank-and-file members of the Screen Actors Guild and American |
| Ratify Contracts. | Federation of Television and Radio Artists have overwhelmingly |
| | approved a new contract with commercial advertisers. |
| Nasdaq Ends Up | What looked like a promising day on Wall Street turned sour late in |
| 47; Dow Falls 41 | the session when skittish investors caused a technology rally to stall. |
| Legend Airlines | Legend Airlines, a start-up that said it had lost about $1 million a |
| Suspends | week during its first six months of providing first-class service, |
| Operations | suspended operations Saturday while it attempts to raise money. |
| SUV Liability | Two insurance companies are raising liability premiums for sport |
| Insurance May | utility vehicles, pickup trucks and big vans because of evidence that |
| Rise | they cause more damage in accidents, The New York Times reported |
| | Saturday. |
| AT&T To Sell | AT&T Corp. has agreed to sell The Salt Lake Tribune to the owner of |
| Salt Lake | The Denver Post, but managers of Utah's largest newspaper sued in an |
| Tribune | attempt to block the deal. |

Whenever a new clip is to be broadcast, broadcast manager 105 invokes interpreter 255 which reads the text from the transient data database 250, and the appropriate VCTL template from the clip database 140, and creates a VCTL version of the clip.

The following is an example of a VCTL template for a Yahoo! News Clip prior to embedding the actual text into the template by interpreter 255:

<CLIP ExtSource=“YAHOO_NEWS” ExtSourceType=“DB”
bandwidth=“LOW”>
<BUTTON type=“More” caption=“More” Parameters=“$(Digest)” />
<SLIDE title=“Yahoo! News” duration=“10” layout=“footertext”>

<IMG src=“yahoo_logo.wbmp” fieldname=“img1”

alt=“Yahoo!”/>

<TEXT effect=“lines” fieldname=“txt1”>$(Headline)</TEXT>

</SLIDE>
</CLIP>

$(Digest) and $(Headline) are placeholders for the actual text grabbed from the Web page, and interpreter 255 replaces the placeholders by the actual text The following is an example of a clip for a specific Yahoo! story:

<CLIP ExtSource=“YAHOO_NEWS” ExtSourceType=“DB” bandwidth=“LOW”>

<BUTTON type=“More” caption=“More” Parameters=“Rank-and-file members of the Screen Actors Guild and American Federation of Television and Radio Artists have overwhelmingly approved a new contract with commercial advertisers.”/>

<SLIDE title=“Yahoo! News” duration=“10” layout=“footertext”>

```
<IMG src=“yahoo_logo.wbmp” fieldname=“img1”
    alt=“Yahoo!”/>
<TEXT effect=“lines” fieldname=“txt1”>Actors Vote To
    Ratify Contracts.</TEXT>
```

</SLIDE>
</CLIP>

Reference is now made to FIG. 8 which is a schematic illustration of mobile WAP phone 75 displaying converted content on a display screen 280, in accordance with a preferred embodiment of the present invention. The VCTL defines the clip such that initially only the header “Yahoo!” and the news headline “Actors vote to ratify contracts” are shown on screen 280. A user can access the full story by pressing a “More” key 285 on telephone 75.

System Management

Referring back to FIG. 2, system monitor 100 preferably comprises a logging facility capable of recording data to be processed later by a reporting subsystem. Preferably, all items delivered, and any other event that may be relevant in reports, are logged. The logged data must be easily accessed for reporting and should not cause performance degradation.

System monitor 100 preferably also comprises a reporting facility that preferably provides detailed reports regarding service usage, that can be used by content providers and service providers to determine the general acceptance of the service, and the popularity of different types of content. Channel content can be modified according to ratings, and price rates can be established for advertisements based on channel viewing statistics.

In a preferred embodiment, reports provide rating statistics on channel popularity, including, but not limited to, the following details:

How much time was a channel viewed (total of all users in a day/week/month)?

How much an average user watched channel (day/week/month)?

What content (clips/commercials) had the highest rating?

What content (clips/commercials) caused people to switch channels?

How many people participated in an application (out of total channel viewers)?

Which clips and applications were broadcast at a specific time (day/week/month)?

How many “leads” (More, Call, Link) were activated on specific clips?

The logging facility of system monitor 100 can also be used for error tracking and debugging purposes. System statistics, such as those described above, can be shown in real-time by monitor 100. Such statistics are preferably accumulated in the System Statistics database 130, and can be used to identify trends and analyze patterns of system-wide usage.

Although preferred embodiments are described herein with reference to certain protocols and system architectures, the principles of the present invention may similarly be implemented using systems and protocols of other types. Moreover, although these preferred embodiments operate over cellular communication networks, content broadcast base on the principles of the present invention may also be carried out over wireless networks of other types. It will thus be appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

[image]

[image]

[image]

What is claimed is:

1. A method for broadcasting information, comprising:
providing at a host site computer-readable code representing a sequence of frames of content of a broadcast channel;
receiving signals at the host site from a plurality of mobile telephone devices via a wireless network, invoking the broadcast channel; and
transmitting the code via the wireless network to the plurality of mobile telephone devices concurrently, causing the devices to display the sequence of frames to respective users of the devices substantially simultaneously.

2. A method according to claim 1, wherein the network comprises a cellular telephone network.

3. A method according to claim 2, wherein transmitting the code comprises transmitting packet data over the cellular telephone network.

4. A method according to claim 3, wherein transmitting the packet data comprises transmitting the data in accordance with a Wireless Access Protocol (WAP).

5. A method according to claim 1, wherein providing the code comprises generating the code in a mark-up language, which is read by respective browser programs running on the mobile telephone devices.

6. A method according to claim 5, wherein the mark-up language comprises a language selected from a group of languages consisting of Extensible Markup Language (XML), Wireless Markup Language (WML), Hypertext Markup Language (HTML) and Handheld Device Markup Language (HDML).

7. A method according to claim 5, wherein generating the code comprises generating multiple pages of the mark-up language code, and wherein transmitting the code comprises transmitting the mark-up language code together with scripts, which cause the browser programs to display the content of the multiple pages in succession.

8. A method according to any of claims 1-7, wherein receiving the signals comprises receiving indications of respective display capabilities of the mobile telephone devices, and wherein transmitting the code comprises transmitting different code versions to different ones of the mobile telephone devices responsive to the display capabilities thereof.

9. A method according to any of claims 1-7, wherein receiving the signals comprises estimating respective bandwidths available on the network between the mobile telephone devices and the host site based on the received signals, and wherein transmitting the code comprises transmitting different code versions to different ones of the mobile telephone devices responsive to the respective estimated bandwidths.

10. A method according to any of claims 1-7, wherein transmitting the code comprises synchronizing the code among the mobile telephones so that the frames are displayed to the users on a common timeline.

11. A method according to claim 10, wherein each of the frames comprises one or more slides, each of the one or more slides comprising at least one of text and an image for display by the mobile telephone devices.

12. A method according to claim 10, wherein at least one of the frames comprises a link to an application, and the method also comprises receiving an input from one or more of the users invoking the link, and conveying the application to the mobile telephone devices responsive to the input.

13. A method according to any of claims 1-7, wherein providing the code comprises providing multiple codes representing the content of multiple broadcast channels, and wherein invoking the broadcast channel comprises selecting one of the multiple broadcast channels to be displayed on each of the mobile telephone devices.

14. A method for broadcasting information, comprising:
providing at a host site multiple pages of computer-readable markup-language code representing content of a broadcast channel;
receiving signals at the host site from a plurality of mobile telephone devices via a wireless network, invoking the broadcast channel; and
transmitting the code via the wireless network to the plurality of mobile telephone devices together with scripts, which cause respective browser programs mining on the devices to display the content of the multiple pages in succession to respective users of the devices substantially simultaneously.

15. A method according to claim 14, wherein the mark-up language comprises a language selected from a group of languages consisting of Extensible Markup Language (XML), Wireless Markup Language (WML), Hypertext Markup Language (HEML) and Handheld Device Markup Language (HDML).

16. A method according to claim 14, wherein the browser programs comprise microbrowser programs installed as firmware in the mobile telephone devices, and wherein the scripts are written in a scripting language that is executable by the microbrowser programs substantially as installed.

17. A method according to claim 14, wherein transmitting the code comprises transmitting the code to the mobile telephone devices in accordance with a wireless communication protocol, and wherein the scripts cause the mobile telephone devices, upon displaying the content of one of the pages, to request a successive one of the pages from the host site using the protocol.

18. A method according to any of claims 14-17, wherein at least one of the pages comprises a link to alternative content, such that invocation of the link by one of the users causes the mobile telephone of the one of the users to send a link signal to the host site responsive to one of the scripts associated with the link, and wherein transmitting the code comprises receiving the link signal and, responsive thereto, transmitting the alternative content to the one of the users while the mobile telephone devices of the other users continue to display the multiple pages in succession.

19. A method according to claim 18, wherein transmitting the alternative content comprises conveying an interactive application to the mobile telephone of the one of the users.

20. A method according to claim 18, wherein providing the code comprises providing the multiple pages representing the content of a multiplicity of broadcast channels, and wherein transmitting the alternative content comprises transmitting to the one of the users the code of a second one of the broadcast channels in place of the code of a first one of the broadcast channels.

21. A method according to claim 18, and comprising receiving an indication that the one of the users has finished viewing the alternative content, and wherein transmitting the code comprises continuing to transmit the multiple pages to the one of the users, responsive to the indication, in synchronization with the other users.

22. A method according to claim 18, wherein receiving the link signal comprises receiving the signal invoked by the script associated with the link responsive to the user pressing a button on the telephone device.

23. A method for broadcasting information, comprising:
providing at a host site computer-readable code representing a sequence of frames of content of a broadcast channel;
receiving signals at the host site from a plurality of mobile telephone devices via a wireless network, invoking the broadcast channel;
estimating available network bandwidth between the host site and each of the plurality of mobile telephone devices, based on the received signals;
selecting different versions of the code to transmit to the mobile telephone devices responsive to the available network bandwidth for each of the devices; and
transmitting the different code versions via the wireless network to the plurality of mobile telephone devices concurrently, causing the devices to display the sequence of frames to respective users of the devices substantially simultaneously.

24. A method according to claim 23, wherein the different versions of the code comprise different volumes of code data in at least some of the frames in the sequence.

25. A method according to claim 23, wherein estimating the available network bandwidth comprises sending a test signal from the host site to each of the mobile telephone devices, and measuring an elapsed time until the signals are received at the host site from the mobile telephone devices in response to the test signal.

26. A method according to claim 25, wherein the available network bandwidth is estimated to be inversely proportional to the elapsed time.

27. A method according to claim 23, and comprising periodically repeating the estimating and selecting steps while transmitting the code versions.

28. A method according to any of claims 23-27, wherein receiving the signals further comprises receiving indications of respective display capabilities of the mobile telephone devices, and wherein transmitting the different code versions comprises transmitting the different versions to different ones of the mobile telephone devices responsive to the display capabilities thereof.

29. A method according to any of claims 23-27, wherein transmitting the different code versions comprises synchronizing the code versions among the mobile telephones so that the frames are displayed to the users on a common timeline.

30. A method according to any of claims 23-27, wherein providing the code comprises generating a basic code, and wherein transmitting the different code versions comprises processing the basic code so as to generate the different code versions in a mark-up language, which is read by respective browser programs running on the mobile telephone devices.

31. A method for broadcasting information, comprising:
providing at a host site basic markup language code representing a sequence of frames of content of a broadcast channel;
receiving signals at the host site from a plurality of mobile telephone devices via a wireless network, indicative of respective capabilities of the devices to receive and display the content;
generating different versions of the basic markup language code to transmit to the mobile telephone devices responsive to the respective capabilities of the devices; and
transmitting the different code versions via the wireless network to the plurality of mobile telephone devices concurrently, causing respective browser programs running on the devices to read the markup language code and, responsive thereto, to display the sequence of frames to respective users of the devices substantially simultaneously.

32. A method according to claim 31, wherein generating the different versions comprises generating the versions in one or more languages selected from a group of languages consisting of Extensible Markup Language (XML), Wireless Markup Language (WML), Hypertext Markup Language (HTML) and Handheld Device Markup Language (HDML).

33. A method according to claim 31, wherein providing the basic code comprises providing multiple pages of the code, and wherein transmitting the different code versions comprises transmitting the different code versions together with scripts, which cause the browser programs to display the content of the multiple pages in succession.

34. A method according to claim 31, wherein providing the basic code comprises collecting the content from a plurality of content sources, and converting the content to the basic markup language code.

35. A method according to claim 34, wherein converting the content comprises assembling the content into clips corresponding to the frames, each clip comprising one or more pages of the basic markup language, and providing a schedule indicative of the sequence of the frames, wherein transmitting the different code versions comprises transmitting the versions in accordance with the schedule.

36. A method according to claim 35, wherein assembling the content into the clips comprises defining clip objects in the basic markup language.

37. A method according to claim 34, wherein collecting the content comprises identifying fields on a selected Web page containing the content, and periodically polling the fields on the selected Web page to determine whether the content in the fields has changed, and converting the changed content to the basic markup language.

38. A method according to any of claims 31-37, wherein generating the different versions comprises converting the basic markup language code for one of the frames in the sequence to the different versions while transmitting the different versions of a preceding one of the frames in the sequence to the mobile telephone devices.

39. A method according to any of claims 31-37, wherein generating the different versions comprises producing the versions responsive to different estimates of bandwidth available on the network between the host site and the mobile telephone devices.

40. A method according to any of claims 31-37, wherein generating the different versions comprises producing two or more of the different versions in different markup languages.

41. A wireless broadcast server, comprising a processor, coupled to receive signals via a wireless network from a plurality of mobile telephone devices, invoking a broadcast channel, and to transmit computer-readable code representing content of the broadcast channel via the wireless network to the plurality of mobile telephone devices concurrently, causing the devices to display the content to respective users of the devices substantially simultaneously.

42. A server according to claim 41, wherein the wireless network comprises a cellular telephone network.

43. A server according to claim 42, wherein the code is transmitted as packet data over the cellular telephone network.

44. A server according to claim 43, wherein the packet data is transmitted in accordance with a Wireless Access Protocol (WAP).

45. A server according to claim 41, wherein the computer-readable code comprises code in a mark-up language, which can read by respective browser programs running on the mobile telephone devices.

46. A server according to claim 45, wherein the mark-up language comprises a language selected from a group of languages consisting of Extensible Markup Language (XML), Wireless Markup Language (WML), Hypertext Markup Language (HTML) and Handheld Device Markup Language (HDML).

47. A server according to claim 45, wherein the computer-readable code comprises multiple pages of the mark-up language code, which is transmitted together with scripts which cause the browser programs to display the content of the multiple pages in succession.

48. A server according to any of claims 41-47, wherein the signals comprise indications of respective display capabilities of the mobile telephone devices, and wherein different code versions are transmitted to different ones of the mobile telephone devices responsive to the display capabilities thereof.

49. A server according to any of claims 4147, wherein the signals comprise estimates of respective bandwidths available on the network between the mobile telephone devices and the server, and wherein different code versions are transmitted to different ones of the mobile telephone devices responsive to the respective estimated bandwidths.

50. A server according to any of claims 41-47, wherein the code is synchronized among the mobile telephones so that the frames are displayed to the users on a common timeline.

51. A server according to claim 50, wherein each of the frames comprises one or more slides, each of the one or more slides comprising at least one of text and an image for display by the mobile telephone devices.

52. A server according to claim 50, wherein at least one of the frames comprises a link to an application, and wherein the server is also coupled to receive an input from one or more of the users invoking the link, and, responsive thereto, to convey the application to the mobile telephone devices.

53. A server according to any of claims 41-47, wherein the code comprises multiple codes representing the content of multiple broadcast channels, and the signals invoking the broadcast channel comprise a selection of one of the multiple broadcast channels to be displayed on each of the mobile telephone devices.

54. A wireless broadcast server, comprising a processor, coupled to receive signals via a wireless network from a plurality of mobile telephone devices, invoicing a broadcast channel, and to transmit multiple pages of computer-readable markup-language code representing content of a broadcast channel via the wireless network to the plurality of mobile telephone devices together with scripts, which cause respective browser programs running on the devices to display the content of the multiple pages in succession to respective users of the devices substantially simultaneously.

55. A server according to claim 54, wherein the mark-up language comprises a language selected from a group of languages consisting of Extensible Markup Language (XML), Wireless Markup Language (WML), Hypertext Markup Language (HTML) and Handheld Device Markup Language (HDML).

56. A server according to claim 54, wherein the browser programs comprise microbrowser programs installed as firmware in the mobile telephone devices, and wherein the scripts are written in a scripting language that is executable by the microbrowser programs substantially as installed.

57. A server according to claim 54, wherein the code is transmitted to the mobile telephone devices in accordance with a wireless communication protocol, and wherein the scripts cause the mobile telephone devices, upon displaying the content of one of the pages, to request a successive one of the pages from the host site using the protocol.

58. A server according to any of claims 54-57, wherein at least one of the pages comprises a link to alternative content, such that invocation of the link by one of the users causes the mobile telephone of the one of the users to send a link signal to the host site responsive to one of the scripts associated with the link, and wherein the server is coupled to receive the link signal and, responsive thereto, to transmit the alternative content to the one of the users while the mobile telephone devices of the other users continue to display the multiple pages in succession.

59. A server according to claim 58, wherein the alternative content comprises an interactive application.

60. A server according to claim 58, wherein the code comprises multiple pages representing the content of a multiplicity of broadcast channels, and wherein the alternative content comprises the code of a second one of the broadcast channels.

61. A server according to claim 58, wherein the server is also coupled to receive an indication that the one of the users has finished viewing the alternative content, and to transmit the multiple pages to the one of the users, responsive to the indication, in synchronization with the other users.

62. A server according to claim 58, wherein the link signal is invoked by the script associated with the link responsive to the user pressing a button on the telephone device.

63. A wireless broadcast server, comprising a processor, coupled to receive signals via a wireless network from a plurality of mobile telephone devices, invoking a broadcast channel;
estimate available network bandwidth between the server and each of the plurality of mobile telephone devices, based on the received signals;
select, responsive to the available network bandwidth for each of the devices, different versions of a computer-readable code representing a sequence of frames of content of the broadcast channel, for transmission to the mobile telephone devices; and
transmit the different code versions via the wireless network to the plurality of mobile telephone devices concurrently, causing the devices to display the sequence of frames to respective users of the devices substantially simultaneously.

64. A server according to claim 63, wherein the different versions of the code comprise different volumes of code data in at least some of the frames in the sequence.

65. A server according to claim 63, wherein estimating the available network bandwidth comprises sending a test signal from the host site to each of the mobile telephone devices, and measuring an elapsed time until the signals are received at the host site from the mobile telephone devices in response to the test signal.

66. A server according to claim 65, wherein the available network bandwidth is estimated to be inversely proportional to the elapsed time.

67. A server according to any of claims 63-66, wherein the server periodically repeats the estimation and selection while transmitting the code versions.

68. A server according to any of claims 63-66, wherein the signals further comprise indications of respective display capabilities of the mobile telephone devices, and wherein the different code versions are transmitted to different ones of the mobile telephone devices responsive to the display capabilities thereof.

69. A server according to any of claims 63-66, wherein the transmission of the different code versions is synchronized among the mobile telephones so that the frames are displayed to the users on a common timeline.

70. A server according to any of claims 63-66, wherein the code comprises a basic code, and wherein the different code versions are generated from the basic code in a mark-up language, which is read by respective browser programs running on the mobile telephone devices.

71. A wireless broadcast server, comprising a processor, coupled to:
generate different versions of a basic markup language code representing a sequence of frames of content of a broadcast channel;
receive signals via a wireless network from a plurality of mobile telephone devices, indicative of respective capabilities of the devices to receive and display the content,
transmit, responsive to the respective capabilities of the devices, the different code versions via the wireless network to the plurality of mobile telephone devices concurrently, causing respective browser programs running on the devices to read the markup language code and, responsive thereto, to display the sequence of frames to respective users of the devices substantially simultaneously.

72. A server according to claim 71, wherein the different versions are generated in one or more languages selected from a group of languages consisting of Extensible Markup Language (XML), Wireless Markup Language (WML), Hypertext Markup Language (HTML) and Handheld Device Markup Language (HDML).

73. A server according to claim 71, wherein the basic code comprises multiple pages of the code, and wherein the different code versions are transmitted together with scripts, which cause the browser programs to display the content of the multiple pages in succession.

74. A server according to claim 71, wherein the basic code comprises content collected from a plurality of content sources, converted to the basic markup language code.

75. A server according to claim 74, wherein the content comprises clips corresponding to the frames, each clip comprising one or more pages of the basic markup language, and providing a schedule indicative of the sequence of the frames, wherein the different code versions are transmitted in accordance with a schedule.

76. A server according to claim 75, wherein the clips comprise clip objects defined in the basic markup language.

77. A server according to claim 74, wherein the content comprises fields identified on a selected Web page containing the content, and wherein the server is coupled to periodically poll the fields on the selected Web page to determine whether the content in the fields has changed, and to convert the changed content to the basic markup language.

78. A server according to any of claims 71-77, wherein the basic markup language code for one of the frames in the sequence is converted to the different versions while the different versions of a preceding one of the frames in the sequence is transmitted to the mobile telephone devices.

79. A server according to any of claims 71-77, wherein the different versions are generated responsive to different estimates of bandwidth available on the network between the host site and the mobile telephone devices.

80. A server according to any of claims 71-77, wherein the different versions comprise two or more versions in different markup languages.

81. A computer software product, comprising a computer-readable medium in which program instructions are stored, which instructions, when read by a computer, cause the computer to receive signals via a wireless network from a plurality of mobile telephone devices, invoking a broadcast channel, and to transmit computer-readable code representing content of the broadcast channel via the wireless network to the plurality of mobile telephone devices concurrently, causing the devices to display the content to respective users of the devices substantially simultaneously.

82. A computer software product according to claim 81, wherein the network comprises a cellular telephone network.

83. A computer software product according to claim 82, wherein the code is transmitted as packet data over the cellular telephone network.

84. A computer software product according to claim 83, wherein the packet data is transmitted in accordance with a Wireless Access Protocol (WAP).

85. A computer software product according to claim 81, wherein the code is generated in a mark-up language, which is read by respective browser programs running on the mobile telephone devices.

86. A computer software product according to claim 85, wherein the mark-up language comprises a language selected from a group of languages consisting of Extensible Markup Language (XML), Wireless Markup Language (WML), Hypertext Markup Language (HTML) and Handheld Device Markup Language (HDML).

87. A computer software product according to claim 85, wherein the code comprises multiple pages of the mark-up language code, and wherein the code is transmitted together with scripts, which cause the browser programs to display the content of the multiple pages in succession.

88. A computer software product according to any of claims 81-87, wherein the signals comprise indications of respective display capabilities of the mobile telephone devices, and wherein different code versions are transmitted to different ones of the mobile telephone devices responsive to the display capabilities thereof.

89. A computer software product according to any of claims 81-87, wherein the signals comprise an estimate of respective bandwidths available on the network between the mobile telephone devices and the computer based on the received signals, and wherein different code versions are transmitted to different ones of the mobile telephone devices responsive to the respective estimated bandwidths.

90. A computer software product according to any of claims 81-87, wherein transmission of the code is synchronized among the mobile telephones so that the frames are displayed to the users on a common timeline.

91. A computer software product according to claim 90, wherein each of the frames comprises one or more slides, each of the one or more slides comprising at least one of text and an image for display by the mobile telephone devices.

92. A computer software product according to claim 90, wherein at least one of the frames comprises a link to an application, and wherein the instructions cause the computer to receive an input from one or more of the users invoking the link, and to convey the application to the mobile telephone devices responsive to the input.

93. A computer software product according to claim 91, wherein the code comprises multiple codes representing the content of multiple broadcast channels, and wherein invoking the broadcast channel comprises selecting one of the multiple broadcast channels to be displayed on each of the mobile telephone devices.

94. A computer software product, comprising a computer-readable medium in which program instructions are stored, which instructions, when read by a computer, cause the computer to receive signals via a wireless network from a plurality of mobile telephone devices, invoking a broadcast channel, and to transmit multiple pages of computer-readable markup-language code representing content of the broadcast channel via the wireless network to the plurality of mobile telephone devices together with scripts, which cause respective browser programs running on the devices to display the content of the multiple pages in succession to respective users of the devices substantially simultaneously.

95. A computer software product according to claim 94, wherein the mark-up language comprises a language selected from a group of languages consisting of Extensible Markup Language (XML), Wireless Markup Language (WML), Hypertext Markup Language (HTML) and Handheld Device Markup Language (HDML).

96. A computer software product according to claim 94, wherein the browser programs comprise microbrowser programs installed as firmware in the mobile telephone devices, and wherein the scripts are written in a scripting language that is executable by the microbrowser programs substantially as installed.

97. A computer software product according to claim 94, wherein the code is transmitted to the mobile telephone devices in accordance with a wireless communication protocol, and wherein the scripts cause the mobile telephone devices, upon displaying the content of one of the pages, to request a successive one of the pages from the host site using the protocol.

98. A computer software product according to any of claims 94-97, wherein at least one of the pages comprises a link to alternative content, such that invocation of the link by one of the users causes the mobile telephone of the one of the users to send a link signal to the host site responsive to one of the scripts associated with the link, and wherein transmitting the code comprises receiving the link signal and, responsive thereto, transmitting the alternative content to the one of the users while the mobile telephone devices of the other users continue to display the multiple pages in succession.

99. A computer software product according to claim 98, wherein the alternative content comprises an interactive application.

100. A computer software product according to claim 98, wherein the code comprises multiple pages representing the content of a multiplicity of broadcast channels, and wherein the alternative content is the code of a second one of the broadcast channels.

101. A computer software product according to claim 98, wherein the instructions cause the computer to receive an indication that the one of the users has finished viewing the alternative content, and to transmit the multiple pages to the one of the users, responsive to the indication, in synchronization with the other users.

102. A computer software product according to claim 98, wherein the link signal is invoked by the script associated with the link responsive to the user pressing a button on the telephone device.

103. A computer software product, comprising a computer-readable medium in which program instructions are stored, which instructions, when read by a computer, cause the computer to:
receive signals via a wireless network from a plurality of mobile telephone devices, invoking a broadcast channel;
estimate available network bandwidth between the server and each of the plurality of mobile telephone devices, based on the received signals;
select, responsive to the available network bandwidth for each of the devices, different versions of a computer-readable code representing a sequence of frames of content of the broadcast channel, for transmission to the mobile telephone devices; and
transmit the different code versions via the wireless network to the plurality of mobile telephone devices concurrently, causing the devices to display the sequence of frames to respective users of the devices substantially simultaneously.

104. A computer software product according to claim 103, wherein the different versions of the code comprise different volumes of code data in at least some of the frames in the sequence.

105. A computer software product according to claim 103, wherein estimating the available network bandwidth comprises sending a test signal from the host site to each of the mobile telephone devices, and measuring an elapsed time until the signals are received at the host site from the mobile telephone devices in response to the test signal.

106. A computer software product according to claim 105, wherein the available network bandwidth is estimated to be inversely proportional to the elapsed time.

107. A computer software product according to any of claims 103-106, wherein the instructions cause the computer to periodically repeat the estimation and selection while transmitting the code versions.

108. A computer software product according to any of claims 103-106, wherein the signals further comprise indications of respective display capabilities of the mobile telephone devices, and wherein the different code versions are transmitted to different ones of the mobile telephone devices responsive to the display capabilities thereof.

109. A computer software product according to any of claims 103-106, wherein the transmission of the different code versions is synchronized among the mobile telephones so that the frames are displayed to the users on a common timeline.

110. A computer software product according to any of claims 103-106, wherein the code comprises a basic code, and wherein the different code versions are generated from the basic code in a mark-up language, which is read by-respective browser programs running on the mobile telephone devices.

111. A computer software product, comprising a computer-readable medium in which program instructions are stored, which instructions, when read by a computer, cause the computer to:
generate different versions of a basic markup language code representing a sequence of frames of content of a broadcast channel;
receive signals via a wireless network from a plurality of mobile telephone devices, indicative of respective capabilities of the devices to receive and display the content;
transmit, responsive to the respective capabilities of the devices, the different code versions via the wireless network to the plurality of mobile telephone devices concurrently, causing respective browser programs running on the devices to read the markup language code and, responsive thereto, to display the sequence of frames to respective users of the devices substantially simultaneously.

112. A computer software product according to claim 111, wherein the different versions are generated in one or more languages selected from a group of languages consisting of Extensible Markup Language (XML), Wireless Markup Language (WML), Hypertext Markup Language (HTML) and Handheld Device Markup Language (HDML).

113. A computer software product according to claim 111, wherein the basic code comprises multiple pages of the code, and wherein the different code versions are transmitted together with scripts, which cause the browser programs to display the content of the multiple pages in succession.

114. A computer software product according to claim 111, wherein the basic code comprises content collected from a plurality of content sources, converted to the basic markup language code.

115. A computer software product according to claim 114, wherein the content comprises clips corresponding to the frames, each clip comprising one or more pages of the basic markup language, and providing a schedule indicative of the sequence of the frames, wherein the different code versions are transmitted in accordance with-a schedule.

116. A computer software product according to claim 115, wherein the clips comprise clip objects defined in the basic markup language.

117. A computer software product according to claim 114, wherein the content comprises fields identified on a selected Web page containing the content, and wherein the instructions cause the computer to periodically poll the fields on the selected Web page to determine whether the content in the fields has changed, and to convert the changed content to the basic markup language.

118. A computer software product according to any of claims 111-117, wherein the basic markup language code for one of the frames in the sequence is converted to the different versions while the different versions of a preceding one of the frames in the sequence is transmitted to the mobile telephone devices.

119. A computer software product according to any of claims 111-117, wherein the different versions are generated responsive to different estimates of bandwidth available on the network between the host site and the mobile telephone devices.

120. A computer software product according to any of claims 111-117, wherein the different versions comprise two or more versions in different markup languages.
